(19) United States
(12) Patent Application Publication
(10) Pub. No.: US 2005/0091701 A1
(43) Pub. Date: Apr. 28, 2005

(54) Video transmitting device, receiving device, video transmitting system, video transmitting method, video transmitting program, and storage medium storing video transmitting program

(75) Inventor: Itaru Hogyoku, Kashihara-shi (JP)

Correspondence Address: NIXON & VANDERHYE, PC, 1100 N GLEBE ROAD, 8TH FLOOR, ARLINGTON, VA, 22201-4714, US

(73) Assignee: Sharp Kabushiki Kaisha, Osaka (JP)

(21) Appl. No.: 10/947,485

(22) Filed: Sep. 23, 2004

(30) Foreign Application Priority Data
Oct. 22, 2003 (JP) 2003-361771

(51) Int. Cl. H04N 7/173; H04N 7/16; H04J 3/18

(52) U.S. Cl. 725/146; 725/147; 725/118; 725/116; 725/117

(57) ABSTRACT

A PC includes a processing section and a storage section. The processing section controls operation of the PC, based on connection request data for requesting a connection. The connection request data is transmitted from a receiving device. The storage section stores video to be transmitted to the receiving device. When a connection request data recognizing section of the processing section recognizes the connection request data, a connection is established between the PC and the receiving device that transmitted the connection request data, and a transmission control section transmits a video data file read by a file handling section. In the PC, the processing section includes the connection request data recognizing section and the file handling section. Therefore, even if no instruction is made from the side of the receiving device to the PC by using a remote control, it is possible to transmit video data from the PC to the receiving device, and to reproduce the video data. In addition, the PC can transmit the video data by a transmitting scheme that is in accordance with a function of the receiving device.

### BACKGROUND OF THE INVENTION

(Watching Video by Using TV Set)

In order to view videos, it has been a general practice to use a TV set. In addition to viewing videos transmitted in real time, users can now view desired video contents anytime, by using a videotape recorder, a DVD recorder, or the like device (video recording and reproducing device).

Recently, a video wireless transmitting system has been put into practical use. In the video wireless transmitting system, a TV set and a video recording and reproducing device are connected by wireless. A video signal recorded by the video recording and reproducing device is digitalized, and transmitted to the TV set, which is installed at a remote location. One example of such a system is a wireless transmitting system shown in FIG. 10. FIG. 10 is a block diagram illustrating a wireless communication system including a videotape recorder/DVD recorder (video recording and reproducing device) 105 and a TV set 103.

In the system shown in FIG. 10, the videotape recorder/DVD recorder 105 is connected to a transmitting device 101. Meanwhile, the receiving device 102 is connected to the TV set 103. The transmitting device 101 and the receiving device 102 are connected by wireless.

In this arrangement, first, the videotape recorder/DVD recorder 105 transmits video data to the transmitting device 101. The video data is an analog audio/video (analog A/V) signal. Then, the transmitting device 101 encodes the video data by the MPEG (moving picture experts group) encoding scheme by using an MPEG encoder 106, which is provided inside the transmitting device 101. Next, having been encoded and digitalized by the MPEG encoder 106, the video data (MPEG data) is sent to the receiving device 102 by wireless. The receiving device 102 decodes the video data by an MPEG decoder 110, and converts the video data into an analog A/V signal. The receiving device 102 then reproduces the converted data by the TV set 103, which is connected to the receiving device 102.

The transmission and reception of the video data is controlled by using a remote control 104 of the TV set 103. Specifically, the transmission and reception of the video data can be controlled by transmitting an operation signal to the video recording and reproducing device 105 by using remote control devices 108 and 111. The remote control device 108 is provided in the transmitting device 101, and the remote control device 111 is provided in the receiving device 102.

In addition, in Patent Publication 1 (Japanese Publication for Unexamined Patent Application, Tokukai 2002-135304 (publication date: May 10, 2002)), for example, there is a proposal for a data transmitting system that realizes real-time transmission through a broadband data stream on a wireless network.

(Transmission of Video Data between PCs)

Recently, with the advancement of communication technologies and improvement of performances of personal computers (PCs), there is a widespread use of video transmission technologies using a plurality of PCs. For example, as a video transmitting method using a plurality of PCs, the following operations are generally performed. Video data is stored in one PC, and, from the other PC, a user requests the aforesaid one PC to transmit the video data. In response to the request, the aforesaid one PC transmits the video data to the other PC. The other PC then reproduces the video data.

A specific example of the video transmitting method is the system shown in FIG. 11. FIG. 11, which relates to a conventional art, is a diagram illustrating an arrangement of major parts of a wireless communication system between two PCs (201 and 202) using radio waves as a communication medium. As shown in FIG. 11, in this system, the two PCs (201 and 202) are connected with each other by using radio waves as a transmission medium. In the PC 201, which is on the transmitter side, video data is stored in a file format.

The video data is, for example, analog A/V data such as a broadcasting signal, received by a TV tuner (not shown) or the like device provided outside the transmitter-side PC 201. The video data is stored in the following manner. The video data, which is initially an analog A/V signal, is encoded by the MPEG encoding scheme by using the MPEG encoder 203 of the transmitter-side PC 201. As a result, the video signal is converted into digital data. The video data is then stored in a file format in a hard disk 205 of the transmitter-side PC 201.

On the other hand, the other PC (receiver-side PC 202), which is connected with the transmitter-side PC by wireless, specifies a video data file stored in the transmitter-side PC 201, so as to receive the video data. The video data file is specified by using an external input device 210, such as a keyboard, a mouse, or the like, provided to the receiver-side PC 202. When the video data is transmitted from the transmitter-side PC 201 to the receiver-side PC 202, the receiver-side PC 202 decodes the data by using an MPEG decoder 208. The receiver-side PC 202 executes a video displaying software 209 or the like installed therein. As a result, the decoded data is displayed on a monitor of the PC 202.

(Remote Control of Recording and Reproducing Device and TV Set by Using PCs)

It is also conceivable to build a video transmitting system by combining the foregoing systems, i.e. the system that uses a wireless transmitting and receiving device for obtaining video data from a remotely provided video recording and reproducing device and reproducing the video data by the TV set, and the system in which a plurality of PCs transmit and receive video data. According to this video transmitting system, video data stored in a transmitter-side PC is read by a receiving device distanced from the transmitter-side PC. Then, the video of the video data is viewed by using a TV monitor. In fact, with the widespread use of PCs for the purpose of handling videos, there are increasing demands for viewing a video not on a monitor or the like device of a PC storing the video, but on a TV monitor distanced from the PC.

However, if a user chooses to use a TV monitor to view a video stored in a PC, there are the following problems.

In a PC, video data is stored as a file. Therefore, to reproduce the video data stored in the PC, a device or the like for handling the video data file is required. The file can be handled without a problem if a transmitting device that stores the video data and a receiving device that reads out and reproduces the video data are both PCs. In this case, the receiver-side PC uses an external input device thereof and thereby specifies the file of the video data stored in the transmitter-side PC. In this way, the receiver-side PC obtains desired video data from the transmitter-side PC. The video data can be reproduced by a monitor of the receiver-side PC.

On the other hand, if the receiver-side device is a TV set, and a monitor of the TV set is used for reproducing a video, the video data cannot be reproduced in the above-described manner, unlike the case in which the file is transmitted and received between PCs. This is because the TV set, which is designed to reproduce video data inputted as an analog A/V signal, does not have an external input device for handling a video file stored in a PC.

In view of the circumstance, for example, Patent Publication 2 (Japanese Publication for Unexamined Patent Application, Tokukai 2003-046928 (publication date: Feb. 14, 2003)) proposes a system in which video data (MPEG data) is transmitted from a PC (home server) to an MPEG decoder, and the video data is reproduced on a TV monitor.

Publication 2 discloses an arrangement in which an instruction on how to handle the video data stored in the PC is made from the receiver side by using a remote control. According to this arrangement, the transmission of the video data from the PC to the receiver side is performed always in accordance with an instruction from an external input device, such as a remote control. The arrangement of Patent Publication 2 is aimed at performing trick reproductions, such as fast-forward and slow reproduction. For this purpose, the arrangement of Patent Publication 2 requires keys for instructing these operations. Therefore, the receiver side must have a key for each operation for handling the video data. Therefore, according to the arrangement of Patent Publication 2, many keys must be added to the remote control of the TV set, in order to receive the video data from the PC and reproduce the video data on the TV set. This causes a problem that operating the remote control is complex for a user.

Another problem of the conventional system including a PC that stores video data and a receiving device that receives the video data is that the PC cannot choose a video data transmitting scheme suitable for the receiving device by judging a function of the receiving device.

There are several signal transmitting schemes that can be employed in transmitting, from the PC to the receiving device, video data compressed by an MPEG encoding or the like scheme. For example, if the data is transmitted over a transmission channel in which an error is likely to occur during data transmission, or if time lag between the transmitter side and the receiver side is not acceptable, the data transmission from the PC to the receiving device is generally performed by a transport stream (TS) scheme.

On the other hand, if the data is transmitted over a transmission channel in which an error is unlikely to occur during data transmission, e.g. in the case of data transmission to a storage-type medium such as a DVD recorder, and a time lag between the transmitter side and the receiver side is acceptable, the data is transmitted from the PC to the receiving device by a program stream (PS) scheme. Thus, it is preferable if the PC can choose an appropriate data transmitting scheme in accordance with the type of the receiving device.

### SUMMARY OF THE INVENTION

The present invention was made in light of the foregoing problems. An object of the present invention is therefore to provide a video transmitting device, a receiving device, a video transmitting system, a video transmitting method, a video transmitting program, and a storage medium storing the video transmitting program, each of which make it possible to view video data in a PC by using a device on the side of the receiving device by minimum instructions, and to choose a video data transmitting scheme in accordance with a function of the receiving device.

To attain the foregoing object, a video transmitting device of the present invention, which is provided to a video transmitting system in which video data is transmitted from a video transmitting device to a receiving device over a communication network and reproduced by a display device connected to the receiving device, includes: a video transmitting device control section for controlling operation of the video transmitting device; and a storage device for storing video data in a file format, the video transmitting device control section including a connection request data recognizing section for recognizing connection request data transmitted from the receiving device, the connection request data being data for requesting a connection with the video transmitting device; a file handling section for reading a video data file stored in the storage device; and a transmission control section for transmitting the video data file read by the file handling section to the receiving device, when the connection request data recognizing section recognizes the connection request data, the transmission control section establishing a connection between the video transmitting device and the receiving device that transmitted the connection request data, and the video data file read by the file handling section being transmitted to the receiving device.

Thus, the video transmitting device of the present invention stores video data in a file format, and transmits the video data to a receiving device connected to a display device. For example, the video transmitting device is a server realized by an externally provided personal computer or the like device. The video transmitting device and the receiving device are connected with each other by a communication network. Over the communication network, data can be transmitted and received between the video transmitting device and the receiving device.

The video transmitting device includes a storage device and a video transmitting device control section. The storage device stores externally supplied video data in a file format. For example, the storage device is a readable and writable nonvolatile storage device, such as a hard disk.

The video transmitting device control section controls operation of the video transmitting device. The video transmitting device control section includes a connection request data recognizing section, a file handling section, and a transmission control section.

The connection request data recognizing section recognizes coded information included in connection request data transmitted from the receiving device. For example, after recognizing the connection request data transmitted from the receiving device, the connection request data recognizing section identifies, based on information in the connection request data, the receiving device that made the connection request. This is in order to establish a connection between the video transmitting device and the receiving device. Then, the connection request data recognizing section instructs the file handling section to read a video data file out of the storage device.

The file handling section reads a predetermined file among video data files stored in the video data transmitting device. The file is read in accordance with an instruction made by the connection request data recognizing section. The instruction is made based on the connection request data. After reading the video data, the file handling section transmits the video data to the receiving device.

With this arrangement of the video transmitting device of the present invention, when the connection request data is received from the receiving device, the video transmitting device can establish a connection with the receiving device, and transmit the video data stored therein to the receiving device. In other words, the receiving device can receive the video data stored in the video transmitting device by simply transmitting the connection request data, which is data for requesting a connection, to the video transmitting device.

Therefore, the video transmitting device has an effect that it is possible to transmit the video data to the receiving device without requiring a user's instruction to read the video data file and to transmit the file.

A receiving device of the present invention is provided to a video transmitting system in which video data is transmitted from a video transmitting device to the receiving device over a communication network, and the video data is reproduced by a display device connected to the receiving device, the video transmitting device including: a video transmitting device control section for controlling operation of the video transmitting device; and a storage device for storing video data in a file format, the video transmitting device control section including a connection request data recognizing section for recognizing connection request data transmitted from the receiving device, the connection request data being data for requesting a connection with the video transmitting device; a file handling section for reading a video data file stored in the storage device; and a transmission control section for transmitting the video data file read by the file handling section to the receiving device, when the connection request data recognizing section recognizes the connection request data, the transmission control section establishing a connection between the video transmitting device and the receiving device that transmitted the connection request data, and the video data file read by the file handling section being transmitted to the receiving device, and the receiving device includes: a receiving device control section for controlling operation of the receiving device; and a storage device including a receiving device information management table for managing information on the receiving device, the receiving device control section including a connection request data generating section for generating the connection request data based on the information included in the receiving device information management table; and a decoder section for decoding compressed video data transmitted from the video transmitting device and converting decoded video data into analog data, the receiving device transmitting the connection request data to the video transmitting device when the receiving device is started up.

The receiving device of the present invention receives video data from the video transmitting device of the present invention over a communication network, and reproduces the video data by a display device connected to the receiving device. The receiving device includes a receiving device control section for controlling operation of the receiving device, and a storage device including a receiving device information management table for managing information on the receiving device. The receiving device control section includes a connection request data generating section and a decoder section. The connection request data generating section generates the connection request data. The decoder section decodes the compressed video data transmitted from the video transmitting device, and converts the decoded video data into analog data.

The information on the receiving device is information on, for example, the type of the receiving device, the signal transmitting scheme that allows the receiving device to receive the video data, and/or the function of the receiving device. The information on the receiving device is stored and managed in the receiving device information management table.

When started up, the receiving device transmits the connection request data to the video transmitting device. The receiving device can be started up by supplying power to the receiving device, for example. Therefore, when the receiving device is started up, the connection request data generating section can transmit the connection request data including the information on the receiving device to the video transmitting device.

Thus, a transmission request for the video data file can be made by simply starting up the receiving device. Therefore, the receiving device has an effect that the user does not require an external input device for inputting an instruction to the receiving device.

For a fuller understanding of the nature and advantages of the invention, reference should be made to the ensuing detailed description taken in conjunction with the accompanying drawings.

### BRIEF DESCRIPTION OF THE DRAWINGS

FIG. 1, which shows one embodiment of the present invention, is a block diagram illustrating a video data transmitting system including a PC and a receiving device connected by wireless.

FIGS. 2(a), 2(b), and 2(c) are diagrams illustrating examples of a data structure of connection request data.

FIG. 3 is a flowchart illustrating a procedure for viewing video data in the PC by using a TV set.

FIG. 4 is a flowchart illustrating a method by which the receiving device instructs the PC to transmit a video data file having a specific file name.

FIG. 5 is a flowchart illustrating a method by which the receiving device instructs the PC to transmit a video data file in a specific subdirectory.

FIG. 6 is a flowchart illustrating a method by which the receiving device instructs the PC to transmit a compressed video data file in a specific subdirectory.

FIG. 7 is a block diagram illustrating an example of another embodiment of the system of the present invention.

FIG. 8 is a flowchart illustrating a procedure for transmitting a control signal from the receiving device to the PC and thereby controlling how to handle the video data in the PC.

FIG. 9 is a flowchart illustrating processing by which the PC transmits a still picture of video data to the receiving device in the system of the present invention.

FIG. 10, which shows a prior art, is a block diagram illustrating an arrangement of major parts of a wireless transmitting system including a videotape recorder/DVD recorder and a TV set.

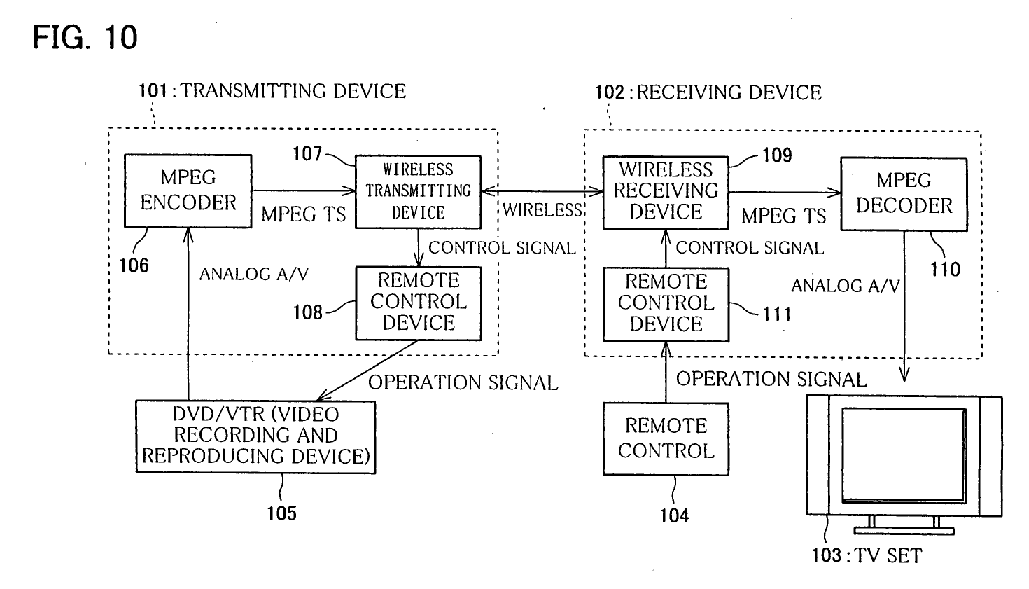

FIG. 11, which relates to a prior art, is a block diagram illustrating an arrangement of major parts of a wireless transmitting system including two PCs that perform wireless communication.

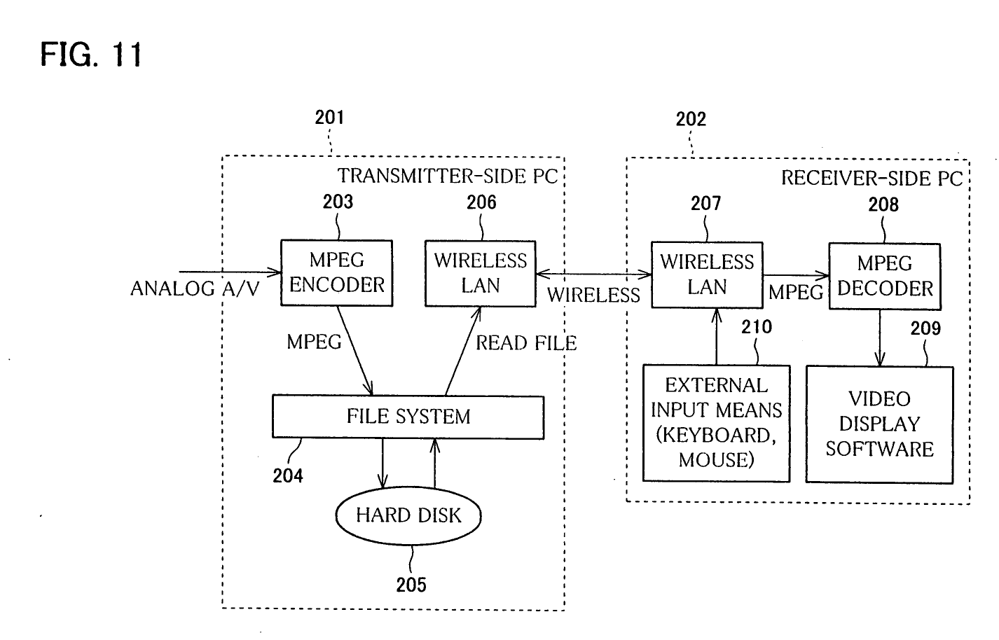

### DESCRIPTION OF THE EMBODIMENTS

The following describes embodiments of the present invention.

(First Embodiment)

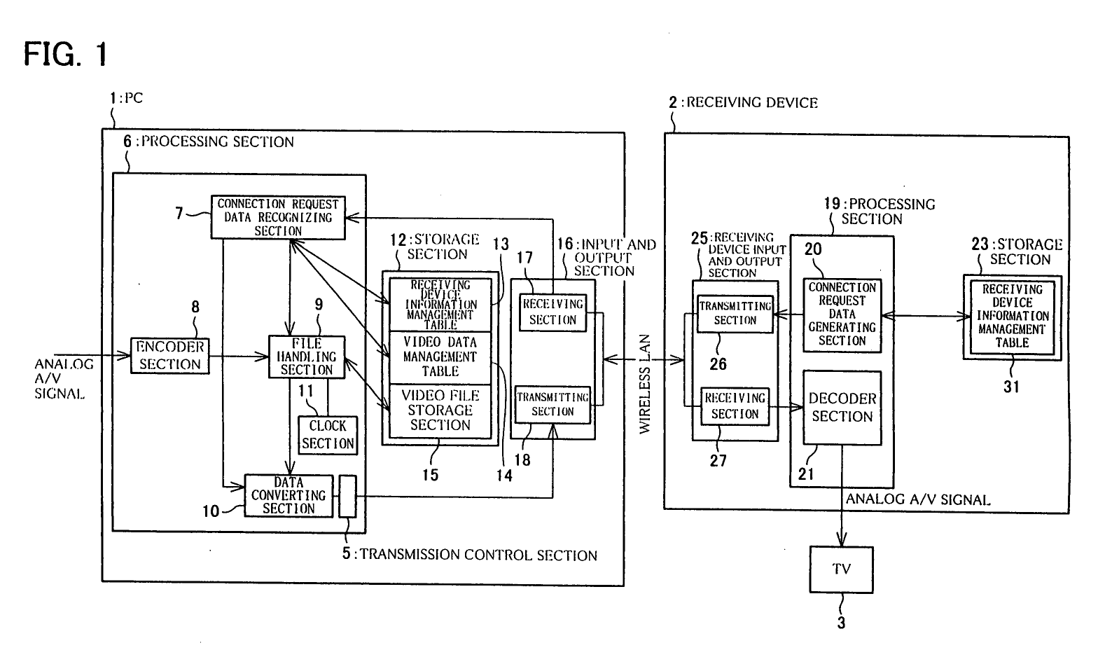

First, with reference to FIGS. 1 to 6, a first embodiment of the present invention is described below.

FIG. 1 is a diagram illustrating an example of a video transmitting system for transmitting video data between a PC 1 and a receiving device 2, which are connected to each other by wireless. The system of the present embodiment transmits video data stored in the PC 1 to the receiving device over a wireless LAN. The video can be displayed on a monitor of a TV set 3, which is connected to the receiving device 2.

In the present embodiment, the PC 1 and the receiving device 2 are connected to each other through a wireless LAN. However, any form of communication may be performed between the PC 1 and the receiving device 2, as long as wireless communication is possible. Alternatively, the PC 1 and the receiving device 2 may be connected by wire, instead of being connected by wireless.

The system includes the PC (video transmitting device) 1 and the receiving device 2. The receiving device 2 is connected to the TV set 3. Video data is inputted in the form of an analog A/V signal to the PC 1 via a TV tuner (not shown) or the like device provided as an external entity.

As shown in FIG. 1, the PC 1 includes a processing section (video transmitting device control section) 6, a storage section 12, and an input and output section 16.

The processing section 6 controls and executes various kinds of processing performed by the PC 1. Details on the arrangement of the processing section 6 of the present embodiment are described later.

The storage section 12 is a readable and writable nonvolatile storage device, such as a hard disk, provided to the PC 1. The storage section 12 includes a video file storage section 15 for storing a compressed video data file received from outside. The compressed video data is compressed into MPEG data or the like.

The storage section 12 also includes a receiving device information management table 13 and a video data management table 14. The receiving device information management table 13 includes various kinds of property information on the receiving device 2, which is connected to the PC 1 through the wireless LAN. The various kinds of property information on the receiving device 2 are information required for the PC 1 to transmit the compressed video data to the receiving device 2 that made a connection request. Examples of such information are: information for identifying the receiving device that made the connection request, information on a signal transmitting scheme that allows the receiving device 2 to handle the compressed video data, and information on the type of the receiving device 2.

The video data management table 14 includes various kinds of information on the compressed video data file stored in the PC 1. Examples of the various kinds of information on the compressed video data file are: the name of the video data file stored in the PC 1, the subdirectory that stores the video data, the date and/or time on which the video data is stored, and the signal transmitting scheme for the stored video data.

The input and output section 16 includes a receiving section 17 and a transmitting section 18. The receiving section 17 and the transmitting section 18 are provided for inputting and outputting signals so as to establish a connection between the PC 1 and the receiving device 2 through a wireless LAN, and to transmit the compressed video data from the PC 1 to the receiving device 2.

Next, an arrangement of the processing section (video transmitting device control section) 6 is described. The processing section 6 includes an encoder section 8, a connection request data recognizing section 7, a file handling section 9, a data converting section 10, a transmission control section 5, and a clock section 11.

The encoder section 8 performs processing for encoding, from analog A/V data to MPEG data, the video data inputted from outside the PC 1. After the conversion by the encoder section 8, the compressed video data is transmitted to the file handling section 9.

The connection request data recognizing section 7 receives connection request data (described later) from the receiving device 2 via the receiving section 17, and reads information of the connection request data. Then, the connection request data recognizing section 7 refers to the receiving device information management table 13, and, based on the connection request data, instructs the file handling section 9 to read the compressed video data file from the video file storage section 15.

When the file handling section 9 receives video data from the encoder section 8, the file handling section 9 stores the video data in a file format in the video file storage section 15. Then, in accordance with an instruction from the connection request data recognizing section 7, the file handling section 9 reads desired compressed video data out of the video file storage section 15. After that, the file handling section 9 transmits the video data to the data converting section 10.

In accordance with the type of the designation device (recording device 2), the data converting section 10 converts the signal transmitting scheme for the compressed video data stored in the video file storage section 15. The signal transmitting scheme is converted into the transport stream (TS) scheme. Thus, if the signal transmitting scheme needs to be converted into the TS scheme before transmitting the video data to the receiving device 2, the data converting device 10 converts the signal transmitting scheme into the TS scheme.

The transmission control section 5 establishes the connection between the PC 1 and the receiving device 2 in accordance with the connection request from the receiving device 2. The transmission control section 5 also instructs the transmitting section 18 to transmit the video data file read by the file handling section 9 to the receiving device 2.

The clock section 11 records the date and/or time on which the video data file obtained from outside is stored in the video file storage section 15 by the file handling section 9. The information on the date and/or time on which the video data is stored is recorded and managed in the video data management table 14.

As shown in FIG. 1, the receiving device 2 includes a receiving device input and output section 25, a storage section 23, and a processing section (receiving device control section) 19. The receiving device 2 is connected to the TV set 3, which is provided outside the receiving device 2.

The receiving device input and output section 25 includes a transmitting section 26 and a receiving section 27. The transmitting section 26 and the receiving section 27 are provided for inputting and outputting signals in accordance with an instruction from the processing section 19, so as to establish the connection between the PC 1 and the receiving device 2 through the wireless LAN, and to receive the compressed video data from the PC 1.

The storage section 23 is a rewritable nonvolatile storage device, such as a flash EEPROM. The storage section 23 stores receiving device information. The receiving device information is information on the receiving device 2, such as the signal transmitting scheme that allows the receiving device 2 to handle the data. In the storage section 23, the receiving device information is stored and managed as a receiving device information management table 31.

The processing section 19 controls and executes various kinds of processing performed by the receiving device 2. The processing section 19 includes a decoder section 21 and a connection request data generating section 20.

The decoder section 21 decodes the compressed video data transmitted from the PC 1, converts the compressed video data into an analog A/V signal, and transmits the analog A/V signal to the TV set 3.

The connection request data generating section 20 generates the connection request data in accordance with the receiving device information stored in the receiving device information management table 31, and transmits the connection request data to the transmitting section 26. The connection request data is described later.

In the present embodiment, the PC 1 transmits and stores the video data by the TS scheme. However, if the signal transmitting scheme that allows the receiving device 2 to receive the video data is the TS scheme, the PC 1 converts the signal transmitting scheme from the PS scheme into the TS scheme. The conversion is performed by the data converting section 10, in accordance with an instruction from the connection request data recognizing section 7. Alternatively, the video data may be stored in the PC 1 in such a manner as to allow for transmission by a scheme other than the TS scheme, and the signal transmitting scheme may be converted into the TS scheme or some other scheme that allows the receiving device 2 to receive the video data.

The processing section 6 of the PC 1 having the foregoing arrangement can be realized, for example, by a CPU (Central Processing Unit) executing a program for realizing processing operation of the following functional blocks: the encoder section 8, the connection request data recognizing section 7, the file handling section 9, the data converting section 10, the transmission control section 5, and the clock section 11.

This program is stored in the storage section 12, for example. When execution of the program is required, the CPU executes the program by reading it into a workspace storage section (not shown), such as a RAM, provided to the processing section 6. The storage section 12, which stores the program, can be a nonvolatile storage medium, such as a hard disk. The program may be stored in a removable medium of some kind, and may be executed by being read out of the removable medium when necessary. Alternatively, the program may be executed after being downloaded from outside over a communication network.

In this system, the PC 1 is used as a transmitter-side device that stores the video data and transmits the video data to the receiving device 2 over the wireless LAN. However, instead of the PC 1, a hard disk recorder including a wireless transmitting device may be used in this system, for example.

In this case, the storage section 12, which stores the program, may be a nonvolatile storage medium, for example. An example of the nonvolatile storage medium is a nonvolatile IC memory, such as a flash EEPROM. The processing section 6 may be hardware such as an IC that realizes the foregoing functional blocks.

Likewise, the processing section 19 of the receiving device 2 can be realized, for example, by a CPU executing a program for realizing processing operation of the following functional blocks: the connection request data generating section 20 and the decoder section 21.

This program is stored in the storage section 23, for example. When execution of the program is required, the CPU executes the program by reading it into a workspace storage section (not shown), such as a RAM, provided to the processing section 19. The storage section 23, which stores the program, can be a nonvolatile storage medium, such as a hard disk. The program may be stored in a removable medium of some kind, and may be executed by being read out of the removable medium when necessary. Alternatively, the program may be executed after being downloaded from outside over a communication network.

The processing section 19 may be hardware such as an IC that realizes the foregoing functional blocks.

(Connection Request Data)

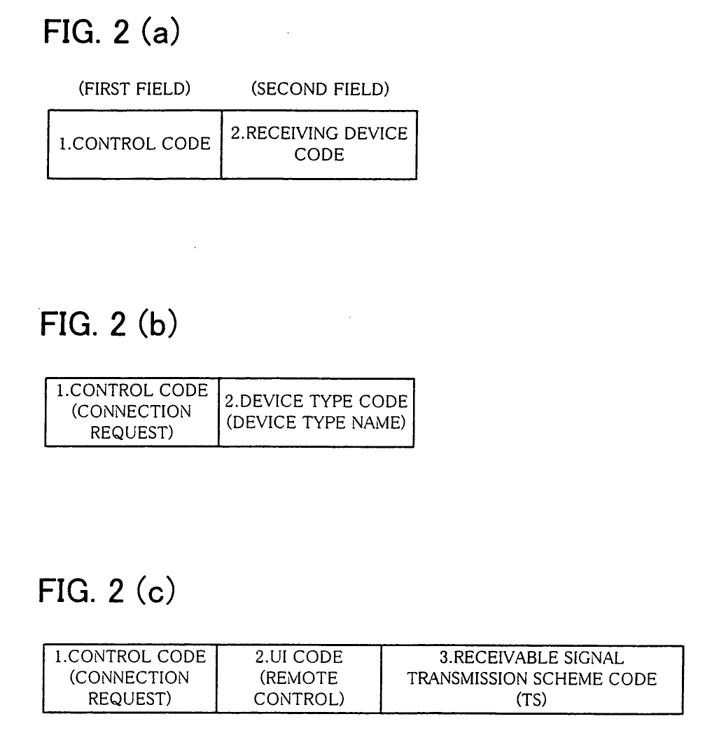

With reference to FIGS. 2(a) to 2(c), the following describes the connection request data. FIGS. 2(a) to 2(c) are diagrams illustrating examples of the data structure of the connection request data. The connection request data includes information (data) for the PC 1 to recognize the connection request made by the receiving device 2 and to identify the receiving device 2 that made the connection request. The information for identifying the receiving device 2 is information on the following subjects: (1) Which receiving device 2 made the connection request? (2) What is the type of the receiving device 2 that made the connection request? and (3) What kind of data signal can the receiving device 2 receive?

As shown in FIG. 2(a), schematically, the connection request data includes a control code and a receiving device code. The control code, which is requested from the receiving device 2 to the PC 1, is a code representing information on the control of the PC 1. The receiving device code is a code representing information on the receiving device 2.

For example, in the case of the connection request data shown in FIG. 2(b), the control code indicates that a receiving device 2 made a connection request to the PC 1. When the control code is received by the PC 1, the connection request data recognizing section 7 recognizes the control code. As a result, the PC 1 can recognize that the connection request was made by the receiving device 2. On the other hand, the receiving device code includes a device type code, which indicates the type of the receiving device 2 that made the connection request. As described later, in the connection request data of the present embodiment, the receiving device code includes identification information (not shown) that allows for identifying the receiving device 2. With this arrangement, the receiving device 2 that made the connection request to the PC 1 is identified. However, the identification information may not be included if it is not necessary to identify the receiving device 2.

Thus, by recognizing the receiving device code at the connection request data recognizing section 7, the PC 1 of the present embodiment identifies the receiving device that made the connection request, and determines the type of the receiving device 2. Then, the PC 1 accesses the receiving device information management table 13 so as to refer to data on the type of the device that made the connection request. In this way, the PC 1 determines which signal transmitting scheme the device of that type conform to.

Alternatively, the connection request data may have the data structure as shown in FIG. 2(c), for example. That is, the connection request data may include a control code, an UI code, and a receiving device code. The control code indicates that a receiving device 2 made a connection request to the PC 1. The receiving device code includes a receivable signal transmitting scheme code. In the data structure shown in FIG. 2(c), as in the foregoing data structure, the receiving device code includes identification information (not shown) that allows for identifying the receiving device 2. With this arrangement, the receiving device 2 that made the connection request to the PC 1 is identified. However, the identification information may not be included if it is not necessary to identify the receiving device 2.

In the data structure shown in FIG. 2(c), the control code indicates that the receiving device 2 made the connection request to the PC 1. The UI code in the receiving device code indicates the type of an external input device that can be used on the side of the receiving device 2. For example, suppose that, in the PC 1, the connection request data recognizing section 7 recognizes that the UI code indicates “remote control”. In this case, it is found that the receiving device 2 can use a remote control as an external input device. The receivable signal transmitting scheme code indicates the signal transmitting scheme that allows the receiving device 2 to reproduce the video data. For example, suppose that, in the PC 1, the connection request data recognizing section 7 recognizes that the receivable signal transmitting scheme code indicates “TS”. In this case, it is found that the receiving device 2 can receive the video data if the video data is transmitted by the TS scheme.

Thus, the receiving device code in the connection request data changes in accordance with the types and the number of types of the information transmitted from the receiving device 2 to the PC 1 when the connection request is made from the receiving device 2 to the PC 1. In other words, the information included in the receiving device code can be determined in accordance with the types and the number of types of information transmitted from the receiving device 2 to the PC 1.

There is an advance arrangement between the PC and the receiving device 2 so that values or codes representing the control code and the receiving device code (e.g. device type code, UI code, and receivable signal transmitting scheme code) are provided at a specific position (e.g. somethingth bite from the first bite) in the connection request data.

(Method for Viewing Movie Data on TV Monitor)

(Establishing Connection)

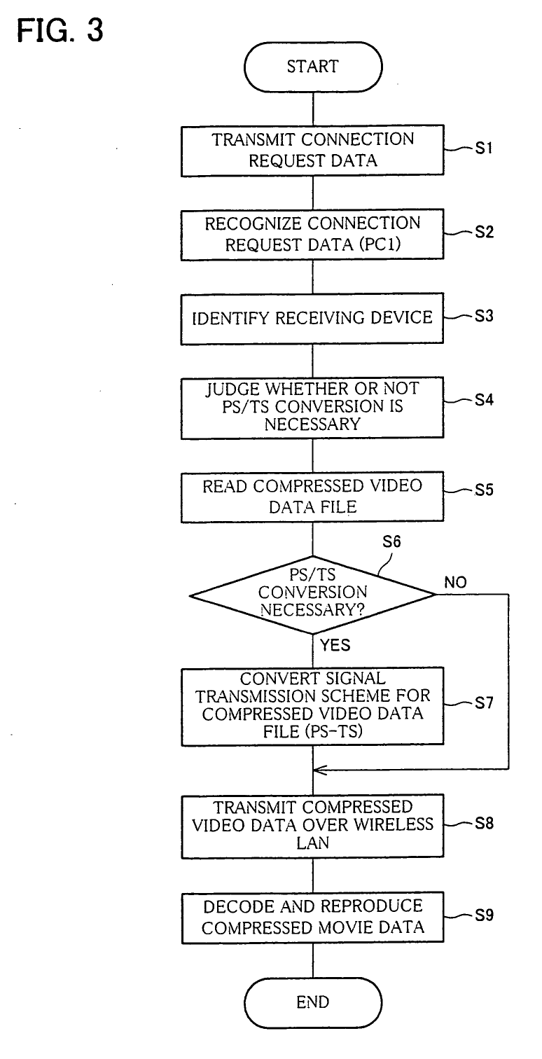

Described next is a procedure for viewing, on the monitor of the TV set 3, the compressed video data stored in the PC 1, according to the foregoing arrangement of the system of the present embodiment (the present system). FIG. 3 is a flowchart illustrating the procedure for viewing, on the TV set 3, the compressed video data stored in the PC 1.

As a premise, suppose that the storage section 15 stores the compressed video data in advance in a file format. That is, suppose that the compressed video data is data made by obtaining a video from a device such as a TV tuner provided outside the PC 1, and encoding and compressing the video by using the encoder section 8. The analog video data inputted by an analog A/V signal scheme is converted into MPEG data through digital conversion and compression processing performed by the encoder section 8. The compressed video data, which is now MPEG data, is stored in the storage section 12 by the file handling section 9 of the PC 1.

In the connection request data transmitted from the receiving device 2 to the PC 1, the control code includes the information representing the connection request, and the receiving device code includes the identification information for the receiving device 2, and the receivable signal transmitting scheme code. Among the information for identifying the receiving device 2, the information on the signal transmitting scheme that allows the receiving device 2 to handle the compressed video data, and the information on the type of the receiving device 2, at least the information for identifying the receiving device 2 is included in the receiving device information management table 12.

However, if the receiving device information management table 12 stores the information on the receivable signal transmitting scheme code of the receiving device 2 in such a manner as to correspond to the identification information for the receiving device 2, the connection request data may not include the receivable signal transmitting scheme code.

With the foregoing premise, in the system of the present embodiment, the video data stored ion the PC 1 is viewed on the TV set 3 according to the following procedure.

First, as shown in FIG. 3, the receiving device 2, which is connected to the TV set 3, transmits the connection request data to the PC 1, which stores the compressed video data (Step 1, hereinafter referred to as S1). The connection request data is transmitted from the receiving device 2 to the PC 1 by the following processing.

When the receiving device 2 is turned ON and activated, the connection request data generating section 20 reads the receiving device information out of the management table 31 of the storage section 23, and generates the connection request data. Then, the connection request data generating section 20 passes the connection request data to the transmitting section 26, and instructs the transmitting section 26 to transmit the connection request data to the PC 1. The transmitting section 26 transmits the connection request data to the PC 1 in accordance with the instruction by the connection request data generating section 20. The PC 1 receives the connection request data at the receiving section 17 of the input and output section 16.

The connection request data generating section 20 may generate the connection request data when the receiving device 2 is activated (started up) by turning ON a “switch to external input” key, which is conventionally provided to the TV set 3.

Next, in the PC 1, the connection request data is inputted from the receiving section 17 to the connection request data recognizing section 7. By receiving the connection request data, the connection request data recognizing section 7 recognizes that the connection request data has been transmitted from the receiving device 2 (S2). Next, based on the connection request data, the connection request data recognizing section 7 recognizes the information on the receiving device 2 that made the connection request. Then, the connection request data recognizing section 7 identifies the receiving device 2 that made the connection request (S3). Thus, based on the identification information included in the connection request data, and with reference to the information for identifying the receiving device 2 included in the receiving device information management table 13, the connection request data recognizing section 7 identifies which receiving device made the connection request. If it is not necessary to identify the receiving device 2 that made the connection request, the connection request data may not include the identification information, and S3 may be omitted.

After identifying the receiving device 2 that made the connection request, the connection request data recognizing section 7 judges, based on the receivable signal transmitting scheme code, whether or not the receiving device 2 requires PS/TS conversion (S4). If the connection request data does not include the receivable signal transmitting scheme code, the connection request data recognizing section 7 judges, with reference to the receiving device information management table 13, whether or not the identified receiving device 2 is of such a type that requires the PS/TS conversion. The connection between the PC 1 and the wireless MPEG receiving device 2 is established in this manner.

(Reading and Transmitting Movie Data)

After the connection is established between the reading device 2 and the PC 1, the PC 1 transmits the compressed video data to the receiving device 2, and the compressed video data is reproduced by the TV set 3, which is connected to the receiving device 2. This procedure is described below.

First, when the connection between the PC 1 and the receiving device 2 is established, the PC 1 reads the compressed video data file (S5). This operation is performed by the file handling section 9, which reads the compressed video data file from the video file storage section 15 of the storage section 12. Therefore, the PC 1 is set so that the file handling section 9 reads, in accordance with an instruction from the connection request data recognizing section 7, the compressed video data file from the video file storage section 15, when the connection between the PC 1 and the reading device 2 is established.

The compressed video data (video data to be transmitted) file, which is read by the file handling section 9 in S5, is preset in the PC 1.

For example, the PC 1 may be set so that, when a connection request is made by the receiving device 2, the file handling section 9 reads a first file of the compressed video data found in the video file storage section 15. Alternatively, the PC 1 may be set so that, when a connection request is made by the receiving device 2, the file handling section 9 reads a predetermined file (predetermined file of the compressed video data) that corresponds to the receiving device 2. If the PC 1 is set so that the file handling section 9 reads the predetermined file of the compressed video data, the predetermined file may be set with respect to each receiving device 2 that made the connection request. The correspondence between the receiving device 2 and the predetermined file can be preset by storing information on the correspondence therebetween in the receiving device management table 17.

The PC 1 may be set so that, if the PC 1 is controlled so as to store the video data obtained from outside always in the same file name in the video file storage section 15, the file handling section 9 reads the compressed video data having the same file name when there is a connection request made by the receiving device 2. If the PC 1 is set so as to read the compressed video data having the same file name, the file name is predetermined between the PC 1 and the receiving device 2. The compressed video data stored in the same file name is always the newest compressed video data. The compressed video data is renamed when newer video data is obtained and stored. Details of the processing in which the file handling section 9 reads the compressed video data having the predetermined file name and transmits the compressed video data from the PC 1 to the receiving device 2 are described later in (Specifying Video Data File to Be Transmitted: Example 1).

The PC 1 may be set so as to store the compressed video data obtained from outside always in a predetermined subdirectory, so that, when there is a connection request by the receiving device 2, the file handling section 9 reads the compressed video data stored in the predetermined subdirectory.

In this case, the compressed video data stored in the predetermined subdirectory is always the newest compressed video data. The predetermined subdirectory is predetermined between the PC 1 and the receiving device 2. The PC 1 may be controlled so that the compressed video data is transferred to another subdirectory when newer compressed video data is obtained and stored. Details of the processing in which the file handling section 9 reads the compressed video data stored in the predetermined subdirectory and transmits the compressed video data from the PC 1 to the receiving device 2 are described later in (Specifying Video Data File to Be Transmitted: Example 2).

The PC 1 may be controlled so as to record the date and/or time on which the video data obtained from outside is stored, and to always read the compressed video data stored in a predetermined date and/or time. In this case, the clock section 11 records the date and/or time on which the compressed video data is stored in the video file storage section 15. The recorded date and/or time is stored in the video data management table 14. Details of the processing in which the file handling section 9 always reads the compressed video data stored in the predetermined date and/or time and transmits the compressed video data from the PC 1 to the receiving device 2 are described later in (Specifying Video Data File to Be Transmitted: Example 3).

In the system of the present embodiment, the video data file read by the file handling section 9 is preset in the PC 1. Therefore, a user is not required to specifically instruct the PC 1, through the receiving device 2, which video data is to be transmitted. Accordingly, it is possible to omit the step in which the user specifically instructs the PC 1, through the receiving device 2, which data is to be transmitted (the step of specifying which file is requested). As a result, even if a remote control 4 is not provided with a key for specifying the file, it is possible to obtain the video data from the PC 1 and view the video.

In the present embodiment, if the video data file read by the file handling section 9 is preset in the PC 1 with respect to each receiving device 2, it is possible to transmit a different file of the video data to each receiving device 2.

In S6, the PC 1 determines whether or not to perform the PS/TS conversion (whether or not it is necessary to perform the PS/TS conversion of the compressed video data to be transmitted is judged in S4).

If it is necessary to perform the PS/TS conversion before transmitting the compressed video data to the receiving device 2 (“YES” in S6), the signal transmitting scheme for the video data is converted by the data converting section 10 from the TS scheme into the TS scheme (S7). If the PS/TS conversion is not necessary, S7 is omitted.

Next, the transmission control section 5 of the PC 1 instructs the transmitting section 18 to transmit the requested compressed video data to the receiving section 27 of the receiving device 2 over a wireless LAN (S8). When the compressed video data is transmitted from the PC 1 to the receiving device 2, the receiving device 2 receives the compressed video data at the receiving section 27. The compressed video data received at the receiving section 27 is inputted to the decoder section 21. The decoder section 21 decodes the compressed video data and converts the compressed video data from digital data to analog data (an analog A/V signal). The video data converted into the analog A/V signal is transmitted to the TV set 3. In this way, the video data is reproduced on the TV set 3 (S9).

In the foregoing processing, in S4, the PC 1 judges whether the signal transmitting scheme that allows the receiving device 2 to receive the video data is the TS scheme or the TS scheme. If the signal transmitting scheme that allows the receiving device 2 to receive the video data is the TS scheme (“YES” in S6), the PC 1 converts the signal transmitting scheme of the data into the TS scheme, in S7.

However, the PC 1 may be arranged so that, if it is known in advance that the receiving device 2 can receive the data only when the data is transmitted by the TS scheme, the PC 1 automatically converts the signal transmitting scheme for video data into the TS scheme and transmit the video data to the recording device 2, without making the foregoing judgment on whether or not it is necessary to convert the video data.

(Specifying Video Data File to Be Transmitted: Example 1)

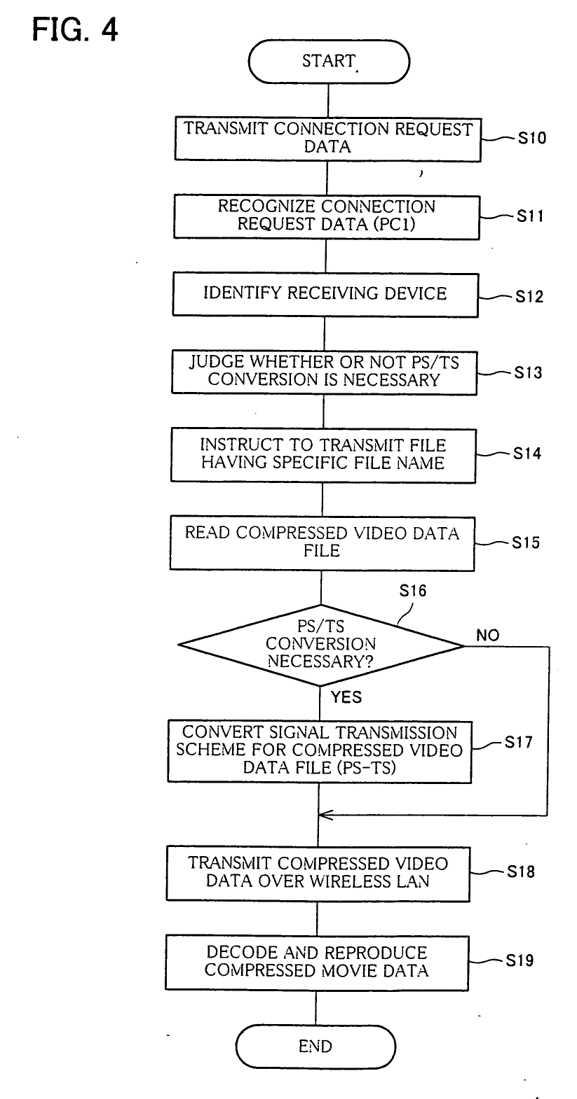

With reference to FIG. 4, the following describes an example of a method by which the file handling section 9 specifies the video data file to be transmitted, among the compressed video data files stored in the video file storage section 15. In the following example, the connection request data transmitted from the receiving device 2 includes information on the file name of the compressed video data requested by the receiving device 2, and the file handling section 9 reads the compressed video data file in accordance with this information.

FIG. 4 is a flowchart illustrating an example of a method by which the receiving device 2 informs the PC 1 of a specific file name of the video data file to be transmitted.

In FIG. 4, S10 to S13 are respectively identical to S1 to S4 shown in FIG. 3. In other words, FIG. 3 and FIG. 4 are identical in those steps performed before the connection between the PC 1 and the receiving device 2 is established through the wireless LAN. Therefore, explanations for the steps in FIG. 4 that are common to the steps in FIG. 3 (S10 to S13 in FIG. 4) are omitted.

When the connection is established between the PC 1 and the receiving device 2, the connection request data recognizing section 7 specifically instructs the file handling section 9 to read the compressed video data having a specific file name, in accordance with the received connection request data (S14). The processing for specifying the file is described below in detail.

As described above, when activated, the receiving device 2 transmits the connection request data to the PC 1. The receiving device code of the connection request data includes identification information on the receiving device and information on the file name of the requested compressed video data. The file name may be set at the time of initial setting or anytime (e.g. once a year, once in every six months) with respect to each receiving device 2. If the file name is set at the time of initial setting, it is not necessary for the user to specify desired compressed video data every time the user requests the PC 1 to transmit compressed video data.

If the file name can be set anytime, the file name of the requested compressed video data can be changed appropriately with respect to each receiving device 2.

In either case, the file name of the requested compressed video data can be set with respect to each receiving device 2. Therefore, when the user requests the transmission of compressed video data, the file handling section 9 can read the compressed video data stored in thus set file name, and transmit the compressed video data from the PC 1 to the receiving section 2. Accordingly, it is not necessary for the user to specify the compressed video data every time the user requests the PC 1 to transmit the compressed video data.

The file name is allocated in advance to each receiving device 2. For example, file name “a” is allocated to one receiving device 2, and file name “b” is allocated to another receiving device 2. The file name allocated to the receiving device 2 is identical to the file name of the compressed video data stored in the PC 1, or corresponds to a specific file of compressed video data.

In this system, by receiving the connection request data transmitted from the receiving device 2, the PC 1 can specify the file that should be read by the file handling section 9 out of the storage section 12. The file name of the compressed video data that should be transmitted to the receiving device is allocated in advance, and the connection request data includes information indicating the file name. Therefore, the file name of the compressed video data to be read by the file handling section 9 needs not be set and stored in advance in the PC 1 with respect to each receiving device that made the connection request.

Next, in accordance with the connection request data, the connection request data recognizing section 7 instructs the file handling section 9 which file to read. Then, in accordance with this instruction, the file handling section 9 chooses and reads the specified file of compressed video data out of the video file storage section 15 (S15). Explanations for S15 to S19 of FIG. 4 are omitted, because these steps are identical to S5 to S9 of FIG. 3, respectively.

Thus, in this system, even if input operation for specifying video data to be transmitted is not performed on the side of the receiving device 2 before the compressed video data is transmitted from the PC 1 to the receiving device 2, the file handling section 9 can, based on the predetermined file name, read the file of the video data to be transmitted, and reproduce, on the TV set 3, the video data stored in the file.

(Specifying Video Data File to Be Transmitted: Example 2)

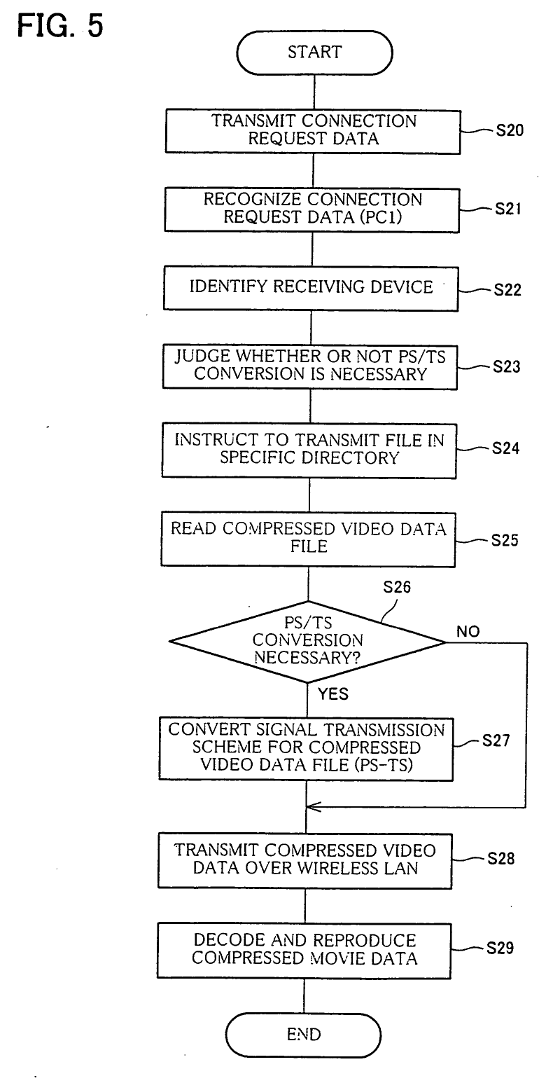

Next, with reference to FIG. 5, the following describes a method by which an instruction is made from the receiving device 2 to the PC 1 so as to specify a file in a specific subdirectory as the video data file to be transmitted. Specifically, the following describes a method by which the file handling section 9 reads the compressed video data file in accordance with information received from the receiving device 2, on the specific subdirectory that stores the compressed video data requested by the receiving device 2.

FIG. 5 is a flowchart illustrating a method by which an instruction is made from the receiving device 2 to the PC 1 so as to specify a file in a specific subdirectory as the video data file to be transmitted. Explanations for S20 to S23 of FIG. 5 are omitted, because these steps are identical to S1 to S4 of FIG. 3, respectively.

First, when the connection is established between the PC 1 and the receiving device 2, the connection request data recognizing section 7 specifically instructs the file handling section 9 to read the compressed video data in a specific subdirectory, in accordance with the received connection request data (S24). The specific subdirectory is a subdirectory that stores the video file to be transmitted.

The processing for specifying the video data to be transmitted that is stored in the specific subdirectory is described below in detail.

When activated (started up), the receiving device 2 of the present embodiment transmits the connection request data to the PC 1. The connection request data includes, as the control code, information representing a connection request. The connection request code also includes, as the receiving device code, information on the receiving device 2 (e.g. information for identifying the receiving device 2) and information on the subdirectory that stores the requested compressed video data. The subdirectory is set with respect to each receiving device 2. For example, the video data stored in subdirectory “A” is always allocated to one receiving device 2, and the video data stored in subdirectory “B” is always allocated to another receiving device 2.

The subdirectory that stores the video data to be transmitted may be set at the time of initial setting or anytime (e.g. once a year, once in every six months) with respect to each receiving device 2. If the subdirectory is set at the time of initial setting, it is not necessary for the user to specify desired compressed video data every time the user requests the PC 1 to transmit compressed video data.

If the subdirectory can be set anytime, the subdirectory that stores the requested compressed video data can be changed appropriately with respect to each receiving device 2.

In either case, the subdirectory that stores the requested compressed video data can be set with respect to each receiving device 2. Therefore, when the user requests the transmission of compressed video data, the file handling section 9 can read the compressed video data stored in thus set subdirectory, and transmit the compressed video data from the PC 1 to the receiving section 2. Accordingly, it is not necessary for the user to specify the compressed video data every time the user requests the PC 1 to transmit the compressed video data.

In the system of the present embodiment, the file read by the file handling section 9 can be specified by the connection request data transmitted from the receiving device 2. This is because, on the side of the receiving device 2, the subdirectory that stores the compressed video data to be transmitted is predetermined, and the connection request data includes information indicating the subdirectory. Therefore, the file to be read by the file handling section 9 needs not be set and stored in advance in the PC 1 with respect to each receiving device 2 that made the connection request.

In this way, in accordance with the connection request data, the connection request data recognizing section 7 instructs the file handling section 9 which file to read. Then, in accordance with the instruction, the file handling section 9 chooses and reads the specified file of the compressed video data out of the video file storage section 15 (S25). Explanations for S25 to S29 of FIG. 5 are omitted, because these steps are identical to S5 to S9 of FIG. 3, respectively.

Thus, in the system of the present embodiment, even if input operation for specifying video data to be transmitted is not performed by the user through the receiving device 2, the file handling section 9 can read, out of the predetermined subdirectory, the video data file to be transmitted, and view, on the TV set 3, the video data stored in the file.

(Specifying Video Data File to Be Transmitted: Example 3)

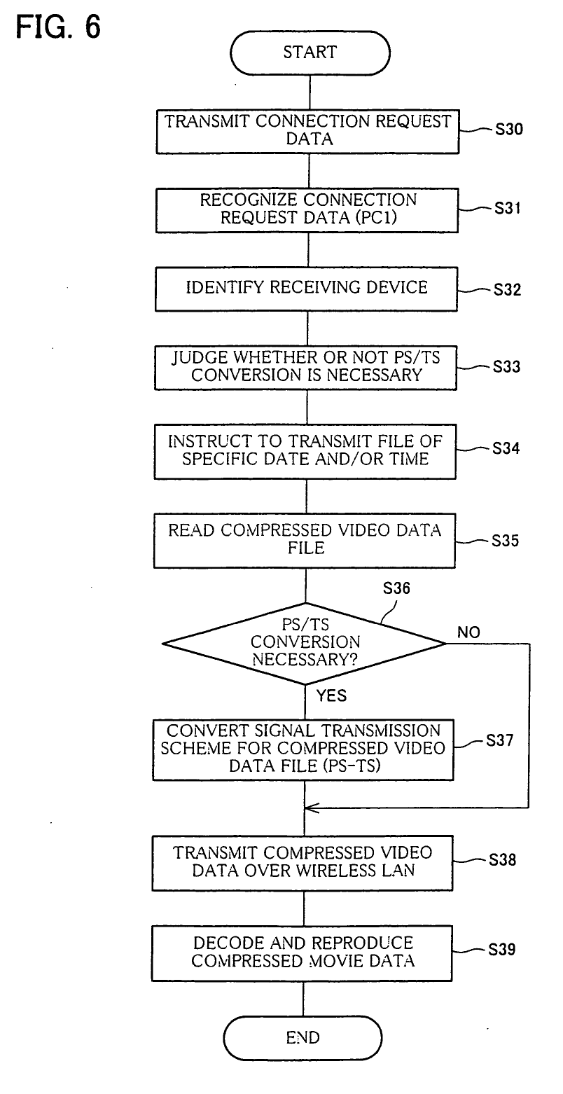

With reference to FIG. 6, the following describes an example of a method by which the file of video data stored on specific date and/or time is specified from the side of the receiving device 2 to the PC 1. Specifically, in the following example, the connection request data transmitted from the receiving device 2 includes information on the specific date and/or time on which the requested compressed video data is stored, and the file handling section 9 reads the compressed video data file in accordance with this information.

FIG. 6 is a flowchart illustrating a method for specifying the video data to be transmitted, which is stored on a specific date and/or time, and allocated with respect to each receiving device 2. Explanations for S30 to S33 of FIG. 6 are omitted, because these steps are identical to S1 to S4 of FIG. 3, respectively.

When the connection is established between the PC 1 and the receiving device 2, the connection request data recognizing section 7 specifies, in accordance with the received connection request data, the compressed video data file stored on specific date and/or time, and instructs the file handling section 9 to read the compressed video data (S5). The specific date and/or time is the date and/or time on which the PC 1 obtains the video data from outside and stores the video data in the storage section 12. The date and/or time is recorded by the clock section 11 when the video data is stored in the PC 1.

In the connection request data transmitted from the receiving section 2, the receiving device code includes information for instructing that the video data stored in the specific date and/or time is to be read. The specific date and/or time is preset to the day on which the receiving device 2 makes the transmission request or to the previous day thereof, for example.

Suppose, for example, that one receiving device transmits to the PC 1 the connection request data that includes information representing a transmission request for the file stored on a specific date and/or time. If the receiving device 2 is preset so as to request the video data stored on the previous day of the transmission of the transmission request data, the receiving device code includes information indicating that the receiving device 2 is requesting the video data stored on the previous day.

The specific date and/or time may be set at the time of initial setting or anytime (e.g. once a year, once in every six months) with respect to each receiving device 2. If the specific date and/or time is set at the time of initial setting, it is not necessary for the user to specify desired compressed video data every time the user requests the PC 1 to transmit compressed video data.

If the specific date and/or time can be set anytime, the specific date and/or time when the requested compressed video data is stored can be changed appropriately with respect to each receiving device 2.

In either case, the specific date and/or time on which the requested compressed video data is stored can be set with respect to each receiving device 2. Therefore, when the user requests the transmission of compressed video data, the file handling section 9 can read the compressed video data stored on thus set specific date and/or time, and transmit the compressed video data from the PC 1 to the receiving section 2. Accordingly, it is not necessary for the user to specify the compressed video data every time the user requests the PC 1 to transmit the compressed video data.

Thus, by recognizing the transmission request data, the connection request data recognizing section 7 can choose and read, out of the video file storage section 15, the compressed video data file stored on the specific date and/or time that is in accordance with the receiving device 2. Since the specific date and/or time on which the video data is stored is set in the receiving device 2, the user is not required to perform input operation for instructing the PC 1 through the receiving device 2 which video file is to be transmitted. Therefore, it is no longer necessary to provide the key for instructing, from the receiving device 2 to the PC 1, which video data file is to be transmitted. Moreover, on the side of the PC 1, it is not necessary to preset the compressed video data to be transmitted in accordance with the connection request by the receiving device 2.

Thus, in accordance with the instruction from the connection request data recognizing section 7, the file handling section 9 chooses and reads, out of the video file storage section 15, the compressed video data file stored on the specific date and/or time (S35). Explanations for the subsequent steps, i.e. S35 to S39 of FIG. 6, are omitted, because these steps are identical to the steps S5 to S9, respectively.

Thus, in the system of the present embodiment, even if no input operation for the PC 1 is performed by the user in order to specify video data to be transmitted, the PC 1 can read the compressed video data file stored on the specific date and/or time, and transmit the file to the receiving device 2. As a result, the video of the video data stored in the file can be viewed on the TV set 3.

(Second Embodiment)

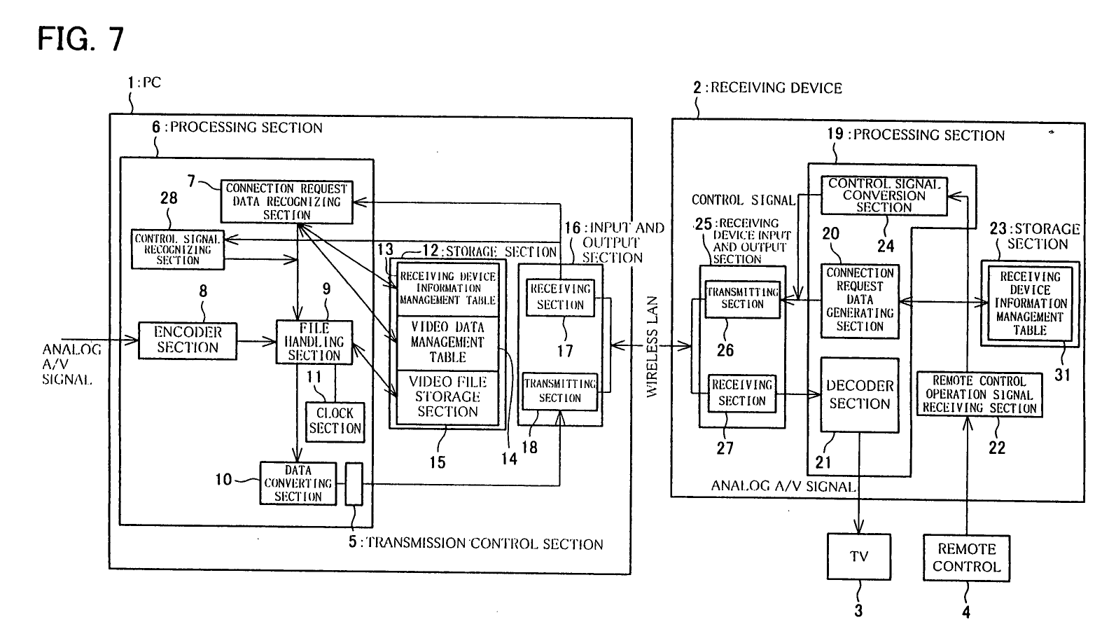

With reference to FIGS. 7 to 9, the following describes “Second Embodiment”, as another embodiment of the system of the present invention. FIG. 7 is a block diagram illustrating another embodiment of the system of the present invention.

In a system (second system) of the Second Embodiment, video data stored in the PC 1 is transmitted to the receiving device 2 over a wireless LAN, and the video is viewed by using a monitor of the TV set 3, which is connected to the receiving device 2.

As in the system of the First Embodiment, the PC 1 and the receiving device 2 may not be connected to each other over the wireless LAN. Any form of communication may be performed between the PC 1 and the receiving device 2, as long as wireless communication is possible. Alternatively, the PC 1 and the receiving device 2 may be connected by wire, instead of being connected by wireless.

The system of the Second Embodiment is different from the system of FIG. 1 in that it is possible to perform input operation for the PC 1 by using a remote control 4. Therefore, members that are identical to the members shown in FIG. 1 are labeled with identical referential numerals, and explanations for such members are omitted.

In this system, the processing section 6 of the PC 1 of the system of FIG. 1 further includes a control signal recognizing section 28. The receiving device 2 of the system of FIG. 1 further includes a remote control operation signal receiving section 22. The receiving device 2 of this system is different from the receiving device 2 of the First Embodiment in that the processing section 19 includes a control signal conversion section 24.

In the system of the Second Embodiment, the remote control (external input device) 4 is provided so as to transmit an operation request from a user of the TV set 3. The user's request for controlling the PC 1 is transmitted as follows: the receiving device 2 receives a remote control operation signal from the remote control 4, and transmits the remote control operation signal as a control signal to the PC 1. The flow of the operation signal from the remote control 4 to the PC 1 is described later.

In the system of the Second Embodiment, the control signal recognizing section 28 of the PC 1 receives a remote control signal transmitted from the receiving device 2, and, in accordance with information of the control signal, instructs the file handling section 9 to stop reading video data, to reproduce video data, or to perform some other control related to video data.

In the second system of the Second Embodiment, the remote control operation signal receiving section 22 of the receiving device 2 receives the operation signal from the remote control 4, and transmits the operation signal to the control signal conversion section 24.

The control signal conversion section 24 converts the signal transmitting scheme for the operation signal received at the remote control operation signal receiving section 22, so that the PC 1 can receive the operation signal transmitted over the wireless LAN. The control signal conversion section 24 also converts the signal transmitting scheme of the operation signal transmitted from the remote control 4 as an external input device of the TV set 3, so that the PC 1 can receive and recognize the signal.

Described next are the remote control operation signal and the remote control signal. The remote control operation signal makes an instruction to the TV set 3, so as to change a channel of the TV set 3, which is installed at a remote location. In the system of the present embodiment, the remote control operation signal is also used so as to transmit the instruction from the user of the TV set 3 through the receiving device 2 to the PC 1.

Described below is a processing flow according to which the user of the TV 3 makes the instruction to the PC 1 through the receiving device 2.

First, in order to cause the PC 1 to perform desired operation, the user presses a key of the remote control 4. When the user presses the key of the remote control 4, the remote control operation signal is transmitted by wireless from the remote control 4 to the receiving device 2.

The receiving device 2 receives the remote control operation signal at the remote control operation signal receiving section 22. Then, the control signal conversion section 24 of the receiving device 2 converts the remote control operation signal into the remote control signal, so that the PC 1 can receive and recognize the signal. The control signal is transmitted by wireless from the receiving device 2 to the PC 1 through the transmitting section 26. When the control signal is received at the receiving section 29, the PC 1 transmits the control signal to the control signal recognizing section 28. The control signal recognizing section 28 recognizes the control signal, and makes an instruction for required control to each section of the processing section 6.

Thus, in the second system, the operation of the PC 1 can be controlled by using the remote control 4. Therefore, by using the remote control 4, the user can make instructions to stop the video data to be transmitted, to transmit the video data again, and the like.

(Controlling PC 1 by Control Signal: Example 1)

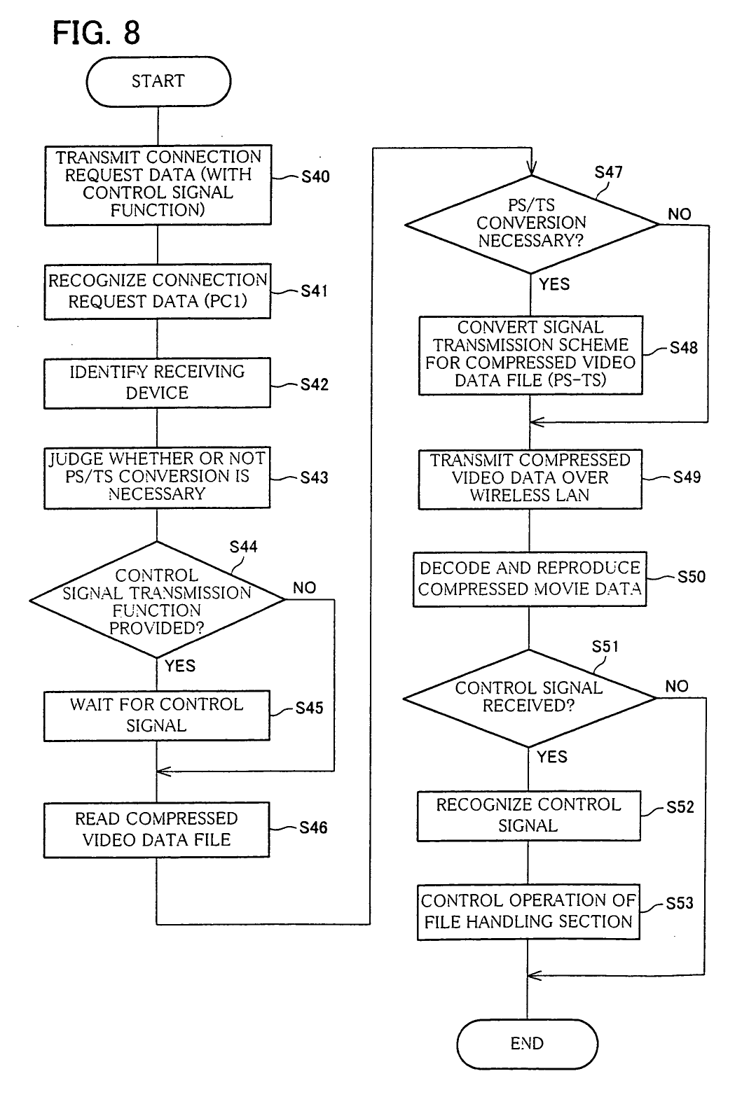

Described next is a procedure by which the control signal is transmitted from the receiving device 2 to the PC 1 so as to control the operation on the video data stored in the PC 1. FIG. 8 is a flowchart illustrating an example of the operation performed on the video data in the PC 1 when the control signal is transmitted from the receiving device 2 to the PC 1.

Here, as a premise, as in the processing steps shown in FIG. 3, the compressed video data is stored in the storage section 12 of the PC 1. Specifically, the PC 1 receives video data from outside by the A/V signal scheme, encodes the video data by using the encoder section 8 provided inside the PC 1, and stores the video data in the video file storage section 15 of the storage section 12.

With this premise, in the second system of the Second Embodiment, the operation on the video data stored in the PC 1 is performed by using the remote control 4 of the TV set 3 according to the following procedure. Explanations for S40 to S43 of FIG. 8 are omitted, because these steps are identical to S1 to S4 of FIG. 3, respectively. However, the steps of FIG. 8 are different from the steps of FIG. 3 in that the connection request data transmitted from the receiving device 2 to the PC 1 further includes a UI code indicating the external input device of the receiving device 2, and the connection request data, which includes the UI code, is transmitted from the receiving device 2 to the PC 1 (S40). In the steps of FIG. 8, the UI code includes information indicating that the remote control 4 is used as the external input device. In other words, the connection request data includes information indicating that the receiving device 2 has a function of receiving the operation signal from the remote control 4 and transmitting the remote control signal for making the operation instruction to the PC 1.

As shown in FIG. 8, the connection request data recognizing section 7 identifies the receiving device 2 based on the connection request data received from the receiving device 2, with reference to the receiving device information management table 13. Then, based on the connection request data, the connection request data recognizing section 7 judges whether or the transmission of the compressed video data to the receiving device 2 needs to be performed by the TS scheme (S40 to S43). Thereafter, based on the connection request data, the connection request data recognizing section 7 judges whether or not the receiving device that made the connection request has the function of transmitting the remote control signal (S44).

If the receiving device 2 that made the connection request has the function of transmitting the remote control signal (“YES” in S44), the PC 1 waits until the control signal is received from the receiving device 2 (S45). Then, in the PC 1, the file handling section 9 reads the compressed video data file (S46). On the other hand, if the receiving device 2 does not have the function of transmitting the remote control signal (“NO” in S44), the file handling section 9 reads the compressed video data file immediately (S46).

The file-reading is performed as follows: based on information on the specific compressed video data required by the receiving device 2 (the information is included in the connection request data), the file handling section 9 reads the predetermined compressed video data from the video file storage section 15.

The information on the specific compressed video data is information on, for example, the file name of the video data to be transmitted, the subdirectory that stores the file to be transmitted, or the specific date and/or time on which the video data to be transmitted is stored.

The subsequent steps S46 to S50, in which (1) the file handling section 9 reads the video data file to be transmitted, and the transmission control section 5 transmits the video data file to the receiving device 2; (2) after receiving the video data, the receiving device 2 decodes the compressed video data and converts it into an analog A/V signal; and (3) the TV set 3 reproduces the video of the video data, are identical to S5 to S9 of FIG. 3. Therefore, explanations for these steps are omitted.

In the second system of the Second Embodiment, if the PC 1 is waiting to receive the remote control signal from the receiving device 2 (S45), the following steps can be performed after the compressed video data stored in the PC 1 is transmitted to the TV set 3 via the receiving device 2 and reproduced by the TV set 3.

For example, in order to stop transmission of a video, the user uses the remote control and thereby transmits a remote control operation signal requesting to stop the transmission. In this case, the operation signal is received by the remote control operation signal receiving section 22 of the receiving device 2, and transmitted to the control signal conversion section 24. The control signal conversion section 24 converts the remote control signal transmitted from the user into the remote control signal, and transmits the remote control signal to the PC 1 via the transmitting section 26.

When the PC 1 receives the remote control signal from the receiving device 2 (“YES” in S51), the control signal recognizing section 28 recognizes the remote control signal (S52). When the remote control signal is recognized, the control signal recognizing section 28 makes an instruction to the file handling section 9 based on the information of the control signal, and thereby controls the operation of the file handling section 9 (S53). Therefore, if the user is requesting to stop the transmission of the video data, the file handling section 9, following the instruction of the control signal recognizing section 28, stops reading the video out of the video file storage section 15.

In the second system of the Second Embodiment, the video data in the PC 1 can be viewed and controlled in the foregoing manner. Moreover, in this system, it is judged whether or not the receiving device 2 has the function of transmitting the remote control signal, and, when the remote control signal is transmitted from the receiving device 2, the operation of the file handling section 9 is controlled in accordance with the instruction of the remote control signal.

(Controlling PC 1 by Control Signal: Example 2)

In (Controlling PC 1 by Control Signal: Example 1), an example of the procedure by which the operation of the file handling section 9 of the PC 1 is controlled in accordance with the control instruction transmitted from the remote control 4 of the TV set 3 has been described.

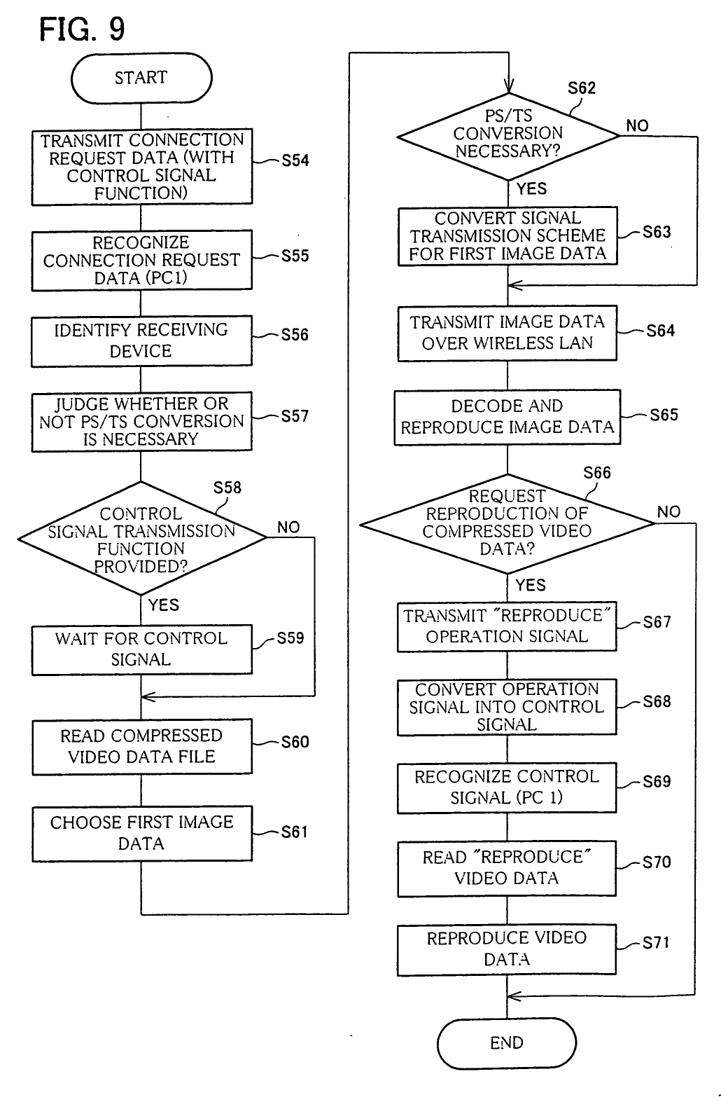

Described next with reference to FIG. 9 is the processing through which, in the system of the present embodiment, the PC 1 transmits a still picture of the compressed video data to the receiving device 2, and the compressed video data to be reproduced by the TV set 3 is chosen with reference to the still picture. FIG. 9 is a flowchart illustrating an example of the processing through which, in the system of the present embodiment, the compressed video data to be reproduced is chosen by the remote control 4 in accordance with the still picture of the compressed video data transmitted from the PC 1. In the present embodiment, the still picture transmitted from the PC 1 to the receiving device 2 is a still picture of the compressed video data at the beginning of reproduction.

Among the processing steps of FIG. 9, S54 to S60 are identical to S40 to S46 of FIG. 8, respectively. Therefore, explanations for S54 to S60 are omitted. However, in S54 to S60, the connection request data transmitted from the receiving device 2 to the PC 1 includes a code requesting a still picture at the beginning of reproduction (start image) of the video data. Therefore, S61 and the subsequent processing in FIG. 9 are different from processing in FIG. 8.

In accordance with the connection request data received from the receiving section 2, the connection request data recognizing section 7 of the PC 1 instructs the file handling section 9 to read the video data to be transmitted. The connection request data recognizing section 7 also instructs the file handling section 9 to obtain the start image of the video data to be transmitted. The file handling section 9 reads a specific video data file out of the video file storage section 15, in accordance with the instruction of the connection request data recognizing section 7. Next, the file handling section 9 chooses and obtains only the data of the start image of the video data among video data files that have been read (S61). Then, if it is necessary to convert the signal transmitting scheme for the data to be transmitted to the receiving device 2 (“YES” in S9), the data of the start image is transmitted from the file handling section 9 to the data converting section 10. The data converting section 10 converts the signal transmitting scheme of the data (S62), and passes the data to the transmission control section 5. The transmission control section 5 instructs the transmitting section 18 of the input and output section 16 to transmit the data of the start image to the receiving device 2 (S64). If it is not necessary to convert the signal transmitting scheme of the data (“NO” in S62), S62 is immediately followed by S64, and the data of the start image is transmitted from the PC 1 to the receiving device 2.

When the receiving device 2 receives the data, the decoder section 21 decodes the data and converts the data into analog data. Then, the decoder section 21 transmits the data to the TV set 3. The video of the data is reproduced on the monitor of the TV set 3 (S65).

By viewing the still picture of the start image reproduced by the TV set 3, the user can know the contents of the compressed video data corresponding to the image. Thus, the user judges whether or not the compressed video data is the data which the user desires to view (S66).

As a result of judgment, if the compressed video data corresponding to the start image received from the PC 1 is the use's desired video data (“YES” in S66), the user presses a key of the remote control 4 for making an instruction to “reproduce”. Then, a remote control operation signal requesting to “reproduce” is transmitted from the remote control 4 to the receiving device 2 (S67). This operation signal is received by the remote control operation signal receiving section 22 of the receiving device 2, and converted into a remote control signal by the control signal conversion section 24 (S68). The remote control signal is transmitted by wireless from the receiving device 2 to the PC 1, received by the receiving section 17 of the PC 1, and recognized by the control signal recognizing section 28 (S69). As a result of recognition, the control signal recognizing section 28 instructs the file handling section 9 to obtain the compressed video data corresponding to the start image that was transmitted to the receiving device 2. In accordance with the instruction, the file handling section 9 reads the compressed video data corresponding to the start image (S70). If the signal transmitting scheme needs to be converted before transmitting the compressed video data read by the file handling section 9, the converting section 10 converts the signal transmitting scheme of the data. After the conversion, the compressed video data is inputted to the transmission control section 5. The transmission control section 5 controls the transmitting section 18 and thereby transmits the compressed video data to the receiving device 2.

When the receiving device 2 receives the compressed video data from the PC 1, the decoder section 21 decodes the data and converts the data into an analog A/V signal, and transmits the data to the TV set 3. Then, the video of the data is reproduced on the monitor of the TV set 3 (S71).

The flow of the operation for viewing the start image on the TV set 3 is specifically described below. In the case of FIG. 9, the file handling section 9 specifies the compressed video data file in accordance with the connection request data. Then, the file handling section 9 transmits the start image (the still picture at the beginning of the compressed video data in this file) to the receiving device 2. Specifically, the file handling section 9 converts the beginning of the compressed video data into a still picture, and transmits it to the receiving section 2. The receiving device 2 always converts the still picture by the decoder section 21 into an analog A/V signal, and keeps transmitting the still picture to the TV set 3. With this arrangement, the start image can be reproduced on the monitor of the TV set 3.

If the receiving device 2 does not have the function of repeatedly transmitting the still picture to the TV set 3, the file handling section 9 of the PC 1 may repeatedly transmit the still picture of the video data to the receiving device 2 for a predetermined period. In this case, the PC 1 may be arranged as follows: when the compressed video data obtained from outside is stored by the file handling section 9 in the video file storage section 15, the compressed video data and the still picture of the video data are stored in different directories, and the correspondence between the compressed video data and the still picture of the video data is stored in the video data management table 14. With this arrangement, if the video data file to be transmitted is specified when a transmission request for the still picture of the compressed video data is made, it is possible, with reference to the video data management table 14, to read the still picture corresponding to the file, and to transmit the file to the receiving device 2.

Thus, the system of the present embodiment is arranged so that the start image of the compressed video data can be transmitted to the receiving device 2 after the connection between the PC 1 and the receiving device 2 is established. Therefore, the user can choose and view the compressed video data after viewing the start image and thereby confirming the contents of the compressed video file.

In the system of the present embodiment, by incorporating, into the connection request data, information on a specific date and/or time, a specific subdirectory, or a specific file name, it is possible to specify the compressed video data that satisfies the condition, and to transmit the still picture of the compressed video data to the receiving device 2. Therefore, the user can obtain, from the PC 1, the compressed video data that satisfies the condition, and reproduce the compressed video data after confirming the contents of the compressed video data by viewing the start image.

Incidentally, the system of the present embodiment is arranged so that the still picture at the beginning of the video data of the compressed video data file is transmitted from the PC 1 to the receiving device 2. However, the system is not limited to this arrangement. For example, the still picture transmitted from the PC 1 to the receiving device 2 may be a desired part of the compressed video data, instead of the start image of the compressed video data. In this case, in the PC 1, the connection request data recognizing section 7 instructs the file handling section 9 to read the compressed video data and transmit the still picture of a predetermined part of the compressed video data. The connection request data recognizing section 7 recognizes information indicating the predetermined part of the compressed video data (this information is included in the connection request data received from the receiving device 2), and then instructs the file handling section 9 which part to obtain as the still picture. The predetermined part is such a part of the compressed video data that is within the reproduction time of the compressed video data and that is of a moment when a predetermined time has elapsed from the start of the video.

Depending on the size of the compressed video data, the video comes to an end before the predetermined time elapses. Therefore, it is preferable if the predetermined part of the compressed video data can be changed in such a manner as to specify the position of the predetermined part in accordance with size information of the compressed video data. The size information can be managed in the video data management table 14.

While the PC 1 is reading the compressed video data, the reading may be interrupted by the user's instruction made by using the remote control 4, and the video data that is nearest the interruption point may be transmitted as the still picture from the PC 1 to the receiving device 2.

In the present example of the second system, the connection request data includes the information representing a transmission request for the still picture of the compressed video data. However, the PC 1 may be preset so as to transmit the still picture of the compressed video data to the receiving device 2 when the connection request from the receiving device 2 is received, even if the connection request data does not include the information indicating the transmission request for the still picture. For example, suppose that the connection request data transmitted from the receiving device 2 includes information representing a transmission request for compressed video data having a specific file name. In this case, in the PC 1, the file handling section 9 reads the compressed video data file having the specific file name, and transmits a still picture of the file to the receiving device 2.

If the PC 1 is set so as to always transmit the still picture of the compressed video data before transmitting the compressed video data to the receiving device 2, the user can reproduce the video after confirming the contents of the video by viewing the still picture, instead of directly reproducing the video.

In the second system, the connection request data includes information representing the transmission request for the still picture, so that the still picture can be transmitted to the receiving device 2 and reproduced by the TV set 3. In addition, in the second system, the operation of the PC 1 can be controlled by the control signal from the remote control 4.

Therefore, the connection request data may include information on transmission requests for still pictures of a plurality of compressed video data files, and the PC 1, after recognizing the connection request data, may respectively transmit the still pictures of the plurality of compressed video data files to the receiving device 2. Then, the user can sequentially view the plurality of still pictures, choose a specific still picture among the plurality of still pictures, and request the PC 1 to transmit the compressed video data corresponding to the chosen still picture.

Specifically, first, the receiving device 2 receives a still picture of one of the plurality of compressed video data files from the PC 1. Then, the still picture is transmitted to the TV set 3 and reproduced by the TV set 3. If the video data corresponding to the still picture is not the user's desired video data, the user, by using the remote control 4, makes a “skip” instruction for requesting the next compressed video data file. The operation for requesting the next file is repeated until the user, by using the remote control 4, transmits an operation signal instructing to “reproduce”.

In this way, the user can sequentially confirm contents of the compressed video data files stored in the PC 1 by viewing the still pictures, and make a reproduction request. Moreover, in order to attain this operation, it is sufficient if the remote control 4 has a “reproduce” key for instructing reproduction and a “skip” key for instructing transmission of the next still picture.

Thus, according to the second system, it is sufficient if the remote control 4 has the keys to “reproduce”, “stop”, and “skip”, in order to choose and reproduce the compressed video data of the desired contents.

In the second system, in which the still pictures are switched, and the video data to be transmitted is chosen and transmitted, the connection request data includes the information representing a transmission request for the still pictures of the plurality of compressed video files. However, instead of this arrangement, the system may be arranged so that the connection request data simply requests transmission of a still picture of one compressed video data file, and, while the still picture is reproduced, an operation signal for instructing to “skip” is transmitted from the remote control 4 so as to switch to a still picture of another compressed video data.

In this case, if the connection request data further includes data for specifying compressed video data files stored in a specific subdirectory, still pictures of the compressed video data files stored in the subdirectory are sequentially read every time the “skip” operation of the remote control 4 is performed. The still pictures may be transmitted to the receiving device 2. In this case, the trigger for stopping the transmission of the still pictures and switching to the transmission of compressed video data is the operation signal for instructing to “reproduce”, which is transmitted from the remote control 4.

Thus, even in the case where only limited keys can be provided, as in the case of the remote control 4 of a conventional TV set, the present system makes it possible to use a conventional remote control, because the present system can be realized simply by the keys to “reproduce”, “stop”, and “skip”.

Moreover, in the foregoing system, in which the still pictures are switched, and the video data to be transmitted is chosen and transmitted, the connection request data includes the information on the still pictures of the plurality of compressed video data files, so as to specify the plurality of compressed video data files. In accordance with the connection request data, the PC 1 sequentially transmits the still pictures of the video data files to the recording device 2.

Instead of the arrangement in which the still pictures are transmitted sequentially, the system may be so arranged that a still picture showing a list of all the plurality of still pictures is transmitted to the receiving device 2. According to this arrangement, in the PC 1, the file handling section 9 chooses the specified compressed video data files in accordance with the connection request data, and respectively reads the still pictures of the video files. Then, the transmission control section 5 makes a list of the still pictures, and instructs the transmitting section 18 to transmit the list as a single still picture to the receiving device 2.

According to this arrangement, the still pictures of the plurality of video data files are transmitted, as a list, to the receiving device 2, and are reproduced by the TV set 3. Then, among the plurality of still pictures, the user chooses a still picture corresponding to desired compressed video data.

The still picture can be chosen by the following operation using the remote control 4. For example, a selection indicator is positioned at one of the still pictures in the list, and the indicator is shifted to another still picture when input operation is performed by using the “skip” key of the remote control 4. When the indicator is positioned at the still picture of the video which the user wishes to view, the user performs input operation by using the “reproduce” key of the remote control 4. By this input operation, an operation signal requesting the transmission of the compressed video data is transmitted as a remote control signal from the receiving device 2 to the PC 1. After receiving the remote control signal, the PC 1 transmits, to the receiving device 2, the compressed video data corresponding to the still picture at which the selection indicator is positioned, among the still pictures in the list. In this way, by using the displayed list of the plurality of still pictures, the user can choose the compressed video data to be reproduced.

Instead of positioning the selection indicator to one of the still pictures in the list, the still picture may be chosen, for example, by numbering each still picture, and specifying the still picture of the desired compressed video data by using the corresponding number provided to the remote control 4 (channel-specifying number). In this case, the video data corresponding to the specified still picture is transmitted to the receiving device 2 after input operation is performed by using the “reproduce” key of the remote control 4.

Thus, in the foregoing system, by using the list of the plurality of still pictures, the user can choose the compressed video data which the user wishes to reproduce.

In the foregoing system, the PC 1 may be preset so that, when the connection request data including data for specifying the plurality of compressed video data files is received from the receiving device 2, the PC 1 sequentially transmits the still pictures of the plurality of compressed video data files to the receiving device 2. Alternatively, the PC 1 may be preset so as to transmit the still pictures of the plurality of compressed video data files as a list.

If the PC 1 is set in this manner, and the receiving device specifies a plurality of compressed video data files, it is ensured that the still pictures corresponding to the plurality of compressed video data files are transmitted. Therefore, the user can make a transmission request for the compressed video data after viewing the plurality of still pictures and thereby confirming the contents of the compressed video data.

### Industrial Applicability

The system of the present invention, which includes a PC 1 and a receiving device 2, is arranged so that the setting of the PC 1 can be changed in accordance with a function of the receiving device 2. Moreover, data stored in the PC 1 can be reproduced on the side of the receiving device 2 with a small number of operation steps. Therefore, video data stored in the PC 1 can be reproduced by a TV set 3, which is distanced from the PC 1.

As described above, a video transmitting device of the present invention includes a video transmitting device control section for controlling operation of the video transmitting device; and a storage device for storing video data in a file format, the video transmitting device control section including a connection request data recognizing section for recognizing connection request data transmitted from the receiving device, the connection request data being data for requesting a connection with the video transmitting device; a file handling section for reading a video data file stored in the storage device; and a transmission control section for transmitting the video data file read by the file handling section to the receiving device, when the connection request data recognizing section recognizes the connection request data, the transmission control section establishing a connection between the video transmitting device and the receiving device that transmitted the connection request data, and the video data file read by the file handling section being transmitted to the receiving device.

Thus, the video transmitting device (PC 1) of the present invention stores video data in a file format, and transmits the video data to the receiving device connected to the display device. For example, the video transmitting device is a server realized by an externally provided personal computer (PC) or the like device. The video transmitting device and the receiving device are connected with each other by a communication network. Over the communication network, data can be transmitted and received between the video transmitting device and the receiving device.

The video transmitting device includes the storage device (storage section 12) and the video transmitting device control section (processing section 6). The storage device stores externally provided video data in a file format. For example, the storage device is a readable and writable nonvolatile storage device, such as a hard disk.

The video transmitting device control section controls the operation of the video transmitting device. The video transmitting device control section includes the connection request data recognizing section (connection request data recognizing section 7), the file handling section (file handling section 9), and the transmission control section (transmission control section 5).

The connection request data recognizing section recognizes coded information included in connection request data transmitted from the receiving device. For example, after recognizing the connection request data transmitted from the receiving device, the connection request data recognizing section identifies, based on information in the connection request data, the receiving device that made the connection request. This is in order to establish a connection between the video transmitting device and the receiving device. Then, the connection request data recognizing section instructs the file handling section to read a video data file out of the storage device.

The file handling section reads a predetermined file among video data files stored in the video data transmitting device. The file is read in accordance with an instruction made by the connection request data recognizing section. The instruction is made based on the connection request data. After reading the video data, the file handling section transmits the video data to the receiving device.

With this arrangement of the video transmitting device of the present invention, a connection between the video transmitting device and the receiving device is established when the connection request data is received from the receiving device, and the video transmitting device can transmit the video data stored therein to the receiving device. In other words, the receiving device can receive the video data stored in the video transmitting device by simply transmitting the connection request data, which is data for requesting a connection, to the video transmitting device.

Therefore, the video transmitting device has an effect that the video transmitting device can transmit the video data to the receiving device without requiring a user's instruction to read the video data file and to transmit the file.

In a video transmitting device of the present invention having the foregoing arrangement, the video transmitting device control section includes a data converting section for converting a signal transmitting scheme for the video data file to be transmitted to the receiving device, the data converting section converting the signal transmitting scheme in accordance with a result of recognition of the connection request data by the connection request data recognizing section.

According to this arrangement, the video transmitting device control section further includes the data converting section (data converting section 10). The data converting section converts a signal transmitting scheme for the video data stored in the video transmitting device. The data converting section converts the signal transmitting scheme for the video data in accordance with a result of recognition of the connection request data by the connection request data recognizing section.

Thus, the connection request data recognizing section recognizes the connection request data, and the video data is transmitted to the receiving device after the signal transmitting scheme for the video data is converted, if necessary according to the result of recognition. Therefore, the video transmitting device has an effect of transmitting the video data by a signal transmitting scheme that allows the receiving device to receive the video data.

In a video transmitting device of the present invention having the foregoing arrangement, the storage device stores a receiving device information management table for storing information for identifying the receiving device and information on a signal transmitting scheme that allows the receiving device to receive the video data file; the connection request data recognizing section analyzes the connection request data so as to identify the receiving device that transmitted the connection request data, and, with reference to the receiving device information management table, the connection request data recognizing section identifies a signal transmitting scheme that allows the identified receiving device to receive the video data file; and the data converting section converts a signal transmitting scheme for the video data file to be transmitted, into the signal transmitting scheme identified by the connection request data recognizing section.

Thus, the storage device further includes information for identifying the receiving device and information on the signal transmitting scheme that allows the receiving device to receive the video data file. In the video transmitting device, the connection request data recognizing section analyzes the connection request data and thereby identifies the receiving device that transmitted the connection request data. This is in order to establish a connection between the video transmitting device and the receiving device. In addition, with reference to the receiving device information management table, the connection request data recognizing section identifies a signal transmitting scheme that allows the receiving device to receive the video data file. If it is necessary to convert the signal transmitting scheme for the video data file to be transmitted, the connection request data recognizing section instructs the data converting section to convert the signal transmitting scheme for the video data file.

With this arrangement of the video transmitting device of the present invention, whether or not it is necessary to convert the signal transmitting scheme of the video data file can be judged according to the type of the receiving device. If the receiving device is of such a type as to require the conversion, the video transmitting device can convert the signal transmitting scheme for the video data file before transmission. Therefore, the video transmitting device has an effect that the signal transmitting scheme for the video data file to be transmitted can be converted if necessary, in accordance with the type of the receiving device.

In addition to the foregoing arrangement, in the video transmitting device of the present invention, the video transmitting device control section includes a control signal recognizing section for recognizing a control signal transmitted from the receiving device; and, if the control signal recognizing section recognizes reception of a control signal for instructing operation for switching a target of reading to another video data, the file handling section switches the target of reading from one video data file to another video data file.

Thus, in the video transmitting device, the video transmitting device control section further includes the control signal recognizing section (control signal recognizing section 28) for recognizing the control signal transmitted from the receiving device. The control signal recognizing section recognizes the control signal transmitted from the receiving device, and makes instructions to the members of the video transmitting device control section, based on the information included in the control signal. The control signal is supplied so as to control the operation of the video transmitting device. The control signal relates to control of operation for which processing is performed on the side of the video transmitting device. Examples of such operation are reproduction (transmission) of the compressed video data and suspension of compressed video data. The control signal can be transmitted to the video transmitting device through the receiving device by using an external input device (e.g. a remote control) provided to the side of the receiving device.

Thus, if the receiving device has the function of transmitting the control signal to the video transmitting device, the video transmitting device can recognize the control signal transmitted from the receiving device, and perform the control in accordance with the result of recognition.

Therefore, in the video transmitting device, if the control signal recognizing section receives and recognizes a control signal for instructing operation for switching a target of reading to another video data, for example, the file handling section can switch the target of reading from one video data to another video data. Moreover, if the control signal recognizing section receives and recognizes a control signal for instructing transmission (reproduction) of video data, the file handling section can pass the video data file that is a current target of reading to the transmission control section, so that the transmission control section can transmit the video data file to the receiving device. Furthermore, if the control signal recognizing section receives and recognizes a control signal for instructing to stop the transmission of video data, the control signal recognizing section can cause the file handling section to stop reading the video data file and thereby stop the transmission of the video data file to the receiving device.

Thus, the video transmitting device can change the control on the transmission of video data in accordance with an instruction of the control signal transmitted from the receiving device.

In a video transmitting device of the present invention having the foregoing arrangement, the file handling section reads a video data file having a predetermined file name among video data files stored in the storage device, and the transmission control section transmits the video data file to the receiving device.

Thus, in the video transmitting device, the file handling section reads the video data file having the predetermined file name among the video data files stored in the storage device, and the transmission control section transmits the video data file to the receiving device. The predetermined file name of the video data file read by the file handling section is an arbitrary file name that is preset in the video transmitting device.

Thus, when the video transmitting device receives the connection request data from the receiving device, and recognizes the connection request data, the video transmitting device transmits the video data file having the predetermined file name. Therefore, the video transmitting device has an effect that it is not necessary to perform operation for specifying, on the side of the receiving device, the video data file to be transmitted. If the predetermined file name is determined with respect to each receiving device, the video transmitting device can use the file name in managing the video data file to be transmitted.

In a video transmitting device of the present invention having the foregoing arrangement, the file handling section reads a video data file stored in a predetermined subdirectory among video data files stored in the storage device, and the transmission control section transmits the video data file to the receiving device.

Thus, the video transmitting device may be arranged so that the file handling section reads a video data file stored in a predetermined subdirectory among video data files stored in the storage device, and the transmission control section transmits the video data file to the receiving device. The predetermined subdirectory storing the video data file read by the file handling section is an arbitrary subdirectory that is preset in the video transmitting device.

Thus, when the video transmitting device recognizes the connection request data transmitted from the receiving device, the video transmitting device transmits the video data file stored in the predetermined subdirectory. Therefore, the video transmitting device has an effect that it is not necessary to perform operation for specifying, on the side of the receiving device, the subdirectory that stores the video data file to be transmitted.

If the predetermined subdirectory is determined with respect to each receiving device, the video transmitting device manages, with respect to each subdirectory, the video data file to be transmitted to the receiving device.

In a video transmitting device of the present invention having the foregoing arrangement, the connection request data includes information on the video data file requested by the receiving device; to the file handling section, the connection request data recognizing section transmits the information on the video data file requested by the receiving device; and, based on the information on the video data file requested by the receiving device, the file handling section determines a video data file to be read.

Moreover, in a video transmitting device of the present invention having the foregoing arrangement, the information on the video data file requested by the receiving device is a file name of the video data file.

Moreover, in a video transmitting device of the present invention having the foregoing arrangement, the information on the video data file requested by the receiving device is a name of a subdirectory in which the video data file is stored, the subdirectory being a subdirectory of the storage device.

That is to say, the video transmitting device may be arranged so as to receive the connection request data including information on the video data file requested by the receiving device, and the connection request data recognizing section recognizes the information on the video data file requested by the receiving device, and instructs the file handling section to transmit the video data file to the receiving device.

Thus, in the video transmitting device, the file handling section can determine which video data file to read, based on the information on the video data file requested by the receiving device (the information is transmitted from the connection request data recognizing section).

Therefore, the video transmitting device has an effect that it is not necessary to predetermine the video data file to be transmitted to the receiving device.

Moreover, the video data file to be transmitted is preset in the receiving device. Therefore, the video transmitting device has an effect that the user on the side of the receiving device is not required to perform operation for specifying the desired video data file.

Furthermore, the information on the video data file requested by the receiving device may be the file name of the video data file. In this case, the file name of the video data file to be transmitted is preset in the receiving device.

Therefore, the video transmitting device has an effect that it is not necessary to predetermine, in the video transmitting device, the file name of the video data file to be transmitted to the receiving device. In addition, the video transmitting device has an effect that the user is not required to perform, on the side of the receiving device, operation for specifying the desired video data file, because the file name of the video data file to be transmitted is preset in the receiving device.

Alternatively, the information on the video data file requested by the receiving device may be the name of the subdirectory (subdirectory of the storage device) storing the video data file. In this case, the subdirectory storing the video data file to be transmitted is preset in the receiving device. Therefore, the video transmitting device can read and transmit the video data file stored in the subdirectory having the name specified by the connection request data. Thus, the video transmitting device has an effect that it is not necessary to predetermine, in the video transmitting device, the video data file to be transmitted to the receiving device. In addition, the video transmitting device has an effect that the user is not required to perform operation for specifying the desired video data file, because the name of the subdirectory storing the video data file to be transmitted is preset in the receiving device.

In a video transmitting device of the present invention having the foregoing arrangement, the storage device further stores a video data file management table for storing information on the video data file; and the video transmitting device control section includes a clock section for recording, in the video data file management table, date and/or time on which the video data file is stored in the storage device.

Moreover, in a video transmitting device of the present invention having the foregoing arrangement, the file handling section reads a video data file stored in the storage device on such date and/or time that is within a predetermined range among video data files stored in the storage device, and transmits the video data file to the receiving device.

Thus, in the video transmitting device, the storage device further stores the video data file management table (video data file management table 14). The video data file management table stores information on the video data file stored in the storage device. Specifically, the video data file management table manages information on the video data file stored in the storage device, such as a location of each video data file in a storage region of the storage device, a file name of each video data file, or a size of each video data file.

Moreover, in the video transmitting device, the video data transmitting device control section includes the clock section (clock section 11) for recording, in the video data file management table, the date and/or time on which the video data file is stored in the storage device.

Thus, the video transmitting device can record, in the video data file management table, the date and/or time on which the video data file is obtained from outside and stored in the storage device. Therefore, by referring to the video data file management table, the video transmitting device can know the date and/or time on which the video data file is stored in the storage device.

According to this arrangement of the video transmitting device, the file handling section can read a video data file stored in the storage device on such date and/or time that is within a predetermined range among video data files stored in the storage device, and transmit the video data file to the receiving device. In this case, the video transmitting device has an effect that it is possible to always transmit the video data file stored in the predetermined date and/or time in the storage device, without specifying, on the side of the receiving device, the video data file to be transmitted.

In a video transmitting device of the present invention having the foregoing arrangement, the connection request data includes information on the video data file requested by the receiving device; to the file handling section, the connection request data recognizing section transmits the information on the video data file requested by the receiving device; based on the information on the video data file requested by the receiving device, the file handling section determines a video data file to be read; and the information on the video data file requested by the receiving device is a range of date and/or time on which the video data file is stored in the storage device.

That is to say, the video transmitting device of the present invention may be arranged so that the connection request data recognizing section recognizes the information on the video data file requested by the receiving device and transmits the information on the video data file to the file handling section, and, based on the information on the video data file, the file handling section determines the video data file to be read.

With this arrangement, if the information on the video data file is the range of date and/or time on which the video data file is stored in the storage device, the file handling section can read, based on the connection request data, the video data file stored on the date and/or time within the range, and transmit the video data file to the receiving device.

Thus, if the range of the date and/or time on which the video data file to be transmitted is preset on the side of the receiving device, the video data stored on the date and/or time can be transmitted to the receiving device. Therefore, the video transmitting device can always transmit the video data file stored on such a date and/or time that is within a predetermined range, without requiring the user to perform operation for specifying, on the side of the receiving device, the range of the date and/or time on which the video data file is stored.

In a video transmitting device of the present invention having the foregoing arrangement, the video transmitting device control section includes a control signal recognizing section for recognizing a control signal transmitted from the receiving device; the video data file transmitted is still picture data in moving picture data; and, if a control signal for instructing moving picture reproduction is received by the control signal recognizing section, the file handling section reads a video data file that is moving picture data including the transmitted still picture data, and the transmission control section transmits the video data file to the receiving device.

Thus, the video transmitting device is arranged so that the video transmitting device control section includes the control signal recognizing section for recognizing a control signal transmitted from the receiving device. When the connection request data recognizing section recognizes the connection request data, the transmission control section transmits, to the receiving device, still picture data in moving picture data.

According to this arrangement of the video transmitting device, if a control signal for instructing moving picture reproduction is received by the control signal recognizing section, the file handling section reads a video data file that is moving picture data including the transmitted still picture data. Then, the transmission control section transmits the video data file to the receiving device. Thus, according to the video transmitting device, the user can transmit a control signal for instructing moving picture reproduction to the video transmitting device through the receiving device, while the still picture is reproduced. In this way, the moving picture data including the still picture can be reproduced. The control signal for instructing moving picture reproduction can be transmitted if a key for instructing reproduction is provided to an external input device (e.g. remote control) provided on the side of the receiving device.

Therefore, the user can reproduce the still picture data transmitted from the video transmitting device, and thereby confirm the contents of the video data including the still picture. Thus, the video transmitting device has an effect that the user can confirm the contents of the video data by viewing the still picture, and then receives and reproduces the moving picture data including the still picture.

In a video transmitting device of the present invention having the foregoing arrangement, if reception of a control signal for instructing switching operation to another video data is recognized by the control signal recognizing section after the still picture data is transmitted to the receiving device, the file handling section reads a video data file that is still picture data in moving picture data that is different from the moving picture data including the transmitted still picture data, and the transmission control section transmits, to the receiving device, the video data file read by the file handling section.

As described above, if the control signal recognizing section recognizes reception of a control signal for instructing switching operation to another video data after the still picture data is transmitted to the receiving device, the file handling section reads a video data file that is still picture data in moving picture data that is different from the moving picture data including the transmitted still picture data. Then, the transmission control section transmits, to the receiving device, the video data file read by the file handling section.

The control signal for instructing switching operation to another video data can be transmitted if a key for instructing the switching operation is provided to an external input device (e.g. remote control) provided on the side of the receiving device.

Therefore, the video transmitting device has an effect that the user can confirm the still picture of the video data file, and, if the still picture is not a still picture of a desired video data file, choose another video data file by the switching operation.

In a video transmitting device of the present invention having the foregoing arrangement, the connection request data includes information indicating whether or not transmission of still picture data in moving picture data is requested; and, if the connection request data recognizing section recognizes that the connection request data includes information representing a transmission request for the still picture data, the transmission control section transmits the still picture data in the moving picture data to the receiving device.

That is to say, the video transmitting device may be arranged so that, if the connection request data includes information indicating whether or not transmission of still picture data in moving picture data is requested, the transmission control section transmits the still picture data in the moving picture data to the receiving device, if the connection request data recognizing section recognizes that the connection request data includes information representing a transmission request for the still picture data.

In other words, according to this arrangement, if the connection request data includes information indicating whether or not transmission of still picture data in moving picture data is requested, the video transmitting device transmits the still picture in the moving picture data of the video data requested by the receiving device.

Therefore, if the receiving device requests the transmission of a still picture in moving picture data, the still picture is transmitted. Therefore, the video transmitting device has an effect that the user can view the still picture and then reproduce the video data corresponding to the still picture. In addition, the video transmitting device is arranged so as to determine, based on the information of the connection request data transmitted from the receiving device, whether or not to transmit the still picture of the requested video data. Therefore, the video data can be transmitted in accordance with an instruction from the side of the receiving device, in accordance with whether or not the receiving device requests the transmission of the still picture.

In a video transmitting device of the present invention having the foregoing arrangement, the video transmitting device control section includes a control signal recognizing section for recognizing a control signal transmitted from the receiving device; the video data file transmitted is list data on still picture data in plural sets of moving picture data; and, if, after the list data is transmitted to the receiving device, the control signal recognizing section recognizes reception of a control signal for instructing operation for choosing a predetermined still picture among a plurality of still pictures in a displayed list of the list data, and receives a control signal for instructing moving picture reproduction, the file handling section reads a video data file that is moving picture data including the still picture data chosen from the displayed list of the list data, and the transmission control section transmits the video data file to the receiving device.

Thus, in the video transmitting device, the video transmitting device control section includes the control signal recognizing section (control signal recognizing section 28) for recognizing a control signal transmitted from the receiving device. Furthermore, the video transmitting device is arranged so that the transmission control section transmits list data on still picture data in plural sets of moving picture data to the receiving device when the connection request data recognizing section recognizes the connection request data. The list data is still picture data for listing up a still picture of the moving picture data in each of a plurality of video data files read out of the storage device by the file handling section.

The list data can be transmitted as follows. The file handling section reads the plurality of video data files out of the storage device, and transmits each still picture to the transmission control section. The transmission control section generates a still picture listing up the plurality of still pictures, and transmits the still picture to the receiving device.

With this arrangement of the video transmitting device, the user can receive the still picture listing up the plural sets of video data from the video transmitting device and reproduce the still picture, by transmitting the connection request data from the receiving device to the video transmitting device. Therefore, the video transmitting device has an effect that the user can view the still pictures of the plural sets of video data and thereby confirm the contents of the plural sets of video data.

Moreover, if, after the list data is transmitted to the receiving device, the control signal recognizing section recognizes reception of a control signal for instructing operation for choosing a predetermined still picture among the plurality of still pictures in a displayed list of the list data, and receives a control signal for instructing moving picture reproduction, the file handling section reads a video data file that is moving picture data including the still picture data chosen from the displayed list of the list data. Then, the transmission control section transmits the video data file to the receiving device.

Therefore, the video transmitting device has an effect that the user can confirm the contents of the plural sets of video data, and then choose the still picture of the desired video data from the plurality of still pictures listed up in the displayed list data and reproduce the video data corresponding to the still picture.

By the following operation, the desired still picture can be chosen from the plurality of still pictures listed up in the displayed list data. For example, a selection indicator is positioned at one of the still pictures in the list, and the indicator is shifted to another still picture when input operation is performed by using a “switch” key provided to an external input device. When the indicator is positioned at the still picture of the video which the user wishes to view, the user performs input operation by using a “reproduce” key provided to the external input device. By these two operations using the external input device, it is possible to select the still picture from the displayed list data.

In a video transmitting device of the present invention having the foregoing arrangement, the connection request data includes information indicating whether or not transmission of the still picture data in the plural sets of video data is requested; and, if the connection request data recognizing section recognizes that the connection request data includes information representing a transmission request for the still picture data, the transmission control section transmits, to the receiving device, still picture data for displaying a list of the plurality of still pictures.

Moreover, in a video transmitting device of the present invention having the foregoing arrangement, the video transmitting device control section includes a control signal recognizing section for recognizing a control signal transmitted from the receiving device; the video data file transmitted is list data on still picture data in plural sets of video data; and, if the control signal recognizing section receives a control signal for instructing operation for choosing a predetermined still picture among a plurality of still pictures in a displayed list of the list data, and receives a control signal for instructing moving picture reproduction, the file handling section reads a video data file that is moving picture data including the chosen still picture data, and the transmission control section transmits the video data file to the receiving device.

Thus, in the video transmitting device, the connection request data includes information indicating whether or not transmission of the still picture data in the plural sets of video data is requested. If the connection request data recognizing section recognizes that the connection request data includes information representing a transmission request for the still picture data, the transmission control section transmits, to the receiving device, still picture data for displaying a list of the plurality of still pictures.

Moreover, in the video transmitting device, the video transmitting device control section includes the control signal recognizing section for recognizing a control signal transmitted from the receiving device.

According to this arrangement of the video transmitting device, the video data file transmitted is the list data listing up a plurality of still pictures in the moving picture data. If the control signal recognizing section receives a control signal for instructing operation for choosing a predetermined still picture among a plurality of still pictures in a displayed list of the list data, and receives a control signal for instructing moving picture reproduction, the file handling section reads a video data file that is moving picture data including the chosen still picture data. Then, the transmission control section transmits the video data file to the receiving device.

Thus, if the receiving device requests transmission of the plurality of still pictures of the video data, the video data transmitting section of the present invention transmits the still picture (list data) listing up the plurality of still pictures. Therefore, the user can view the still pictures displayed in a list. Thus, the video transmitting device has an effect that the user can choose a desired still picture among the plurality of still pictures displayed in the list, and reproduce the video data corresponding to the chosen still picture.

Moreover, based on the information of the connection request data transmitted from the receiving device, the video transmitting device of the present invention determines whether or not to transmit the list data for listing up the still pictures of the requested video data. Therefore, the video data can be transmitted in accordance with the setting of the receiving device as to whether or not to request the list data of still pictures of the video data.

A receiving device of the present invention (present receiving device), which is provided to a video transmitting system in which video data is transmitted from the video transmitting device of the present invention to the receiving device over a communication network, and the video data is reproduced by a display device connected to the receiving device, includes: a receiving device control section for controlling operation of the receiving device; and a storage device including a receiving device information management table for managing information on the receiving device, the receiving device control section including a connection request data generating section for generating connection request data based on the information included in the receiving device information management table; and a decoder section for decoding compressed video data transmitted from the video transmitting device and converting decoded video data into analog data, the receiving device transmitting the connection request data to the video transmitting device when the receiving device is started up.

Thus, the receiving device (receiving device 2) of the present invention receives the video data from the video transmitting device of the present invention over the communication network, and reproduces the video data by the display device (TV set 3) connected to the receiving device. The receiving device includes the receiving device control section (processing section 19) for controlling the operation of the receiving device, and the storage device (storage device 23) including the receiving device information management table (receiving device information management table 31). The receiving device control section includes the connection request data generating section (connection request data generating section 20) and the decoder section (decoder section 21). The connection request data generating section generates the connection request data based on the information included in the receiving device information management table. The decoder section decodes the compressed video data transmitted from the video transmitting device and converts the decoded video data into analog data. The information on the receiving device is information on the type of the receiving device, information on the signal transmitting scheme that allows the receiving device to receive the video data, information on the function of the receiving device, or the like. The information is stored and managed in the receiving device management table.

When started up, the receiving device transmits the connection request data to the video transmitting device. The receiving device can be started up by supplying power to the receiving device, for example. Thus, when the receiving device is started up, the connection request data generating section can transmit the connection request data including the information on the receiving device to the video transmitting device.

Thus, the transmission of the video data file can be requested to the video transmitting device by starting up the receiving device. Therefore, the receiving device has an effect that the user does not require an external input device for inputting instructions to the receiving device.

In the present receiving device, the decoder section decodes the video data transmitted from the video transmitting device, and converts the decoded video data into analog data. Therefore, it is possible to reproduce the video of the video data by using a display device (e.g. a TV set) that can receive analog data as an input signal.

A receiving device of the present invention having the foregoing arrangement further includes: an operation signal receiving section (remote control signal receiving section 22) for receiving an operation signal from an external input device, the receiving device control section including a control signal conversion section for converting the operation signal from the external input device into a control signal that can be received by the video transmitting device.

Thus, the receiving device of the present invention having the foregoing arrangement further includes the operation signal receiving section for receiving an operation signal from the external input device. The receiving device control section includes the control signal conversion section for converting the operation signal from the external input device into a control signal that can be received by the video transmitting device.

Therefore, the present receiving device can receive the operation signal from the external input device, converts the operation signal into a control signal that can be recognized by the video transmitting device, and transmits the control signal to the video transmitting device. The external input device can be realized by a device such as a remote control. The operation signal includes information on operation requested from the side of the receiving device to the video transmitting device. The operation signal can be transmitted to the video transmitting device because the control signal conversion section converts the operation signal into a control signal that can be received by the video transmitting section.

Therefore, the present receiving device has an effect that the user (viewer of video data) can control the operation of the video transmitting device by using the external input device.

A video transmitting system of the present invention includes the video transmitting device and the receiving device.

Specifically, the video transmitting system of the present invention (present video transmitting system) includes: the video transmitting device including (a) the storage device, and (b) the video transmitting device control section including the connection request data recognizing section, the file handling section, and the transmission control section; and the receiving device including (c) the receiving device control section including the connection request data generating section and the decoder section, and (d) the storage device storing the receiving device information management table.

Therefore, the receiving device can generate the connection request data, and transmit the connection request data to the video transmitting device. The video transmitting device recognizes the connection request data, identifies the receiving device making the connection request, and establishes a connection. Then, the video transmitting device can receive the video data to the receiving device. The receiving device receives the video data, decodes and converts the video data into analog data, and transmits the video data to the display device. As a result, the receiving device has an effect that the video data can be reproduced by the display device.

A video transmitting method of the present invention uses a video transmitting device including a video transmitting device control section for controlling operation of the video transmitting device in accordance with connection request data transmitted from a receiving device so as to request a connection; and a storage device for storing video data in a file format, the video transmitting device control section including a connection request data recognizing section for recognizing the connection request data; a file handling section for reading a video data file stored in the storage device; and a transmission control section for transmitting the video data file read by the file handling section to the receiving device, and the method includes the steps of: recognizing information on the receiving device at the connection request data recognizing section, based on the connection request data received from the receiving device over a communication network; reading video data at the file handling section in accordance with a result of recognition by the connection request data recognizing section; and transmitting the video data to the receiving device.

Thus, the video transmitting method of the present invention (present video transmitting method) includes the steps of: recognizing information on the receiving device at the connection request data recognizing section, based on the connection request data received from the receiving device over the communication network; reading video data at the file handling section; and transmitting the video data from the transmission control section to the receiving device.

Therefore, in the present video transmitting method, the connection request data recognizing section recognizes the connection request data transmitted from the receiving device, and thereby identifies the receiving device. This is for establishing a connection between the video transmitting device and the receiving device. Then, the file handling section reads the video data, and the transmission control section transmits the video data file to the receiving device.

Thus, by transmitting the connection request data from the receiving device, the video data file is transmitted to the receiving device. Therefore, the user is not required to perform operation for specifying which video data file is to be read out of the video transmitting device. As a result, the video transmitting method has an effect that the user can reproduce the video data stored in the video transmitting device, even if there is no external input device for performing this operation.

A video transmitting program of the present invention is a program for causing a computer to function as the video transmitting device of the present invention.

A storage medium of the present invention is a computer-readable storage medium storing the video data transmitting program.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A video transmitting device provided to a video transmitting system in which video data is transmitted from a video transmitting device to a receiving device over a communication network and reproduced by a display device connected to the receiving device, the video transmitting device comprising:
a video transmitting device control section for controlling operation of the video transmitting device; and
a storage device for storing video data in a file format,
the video transmitting device control section including
a connection request data recognizing section for recognizing connection request data transmitted from the receiving device, the connection request data being data for requesting a connection with the video transmitting device;
a file handling section for reading a video data file stored in the storage device; and
a transmission control section for transmitting the video data file read by the file handling section to the receiving device,
when the connection request data recognizing section recognizes the connection request data, the transmission control section establishing a connection between the video transmitting device and the receiving device that transmitted the connection request data, and the video data file read by the file handling section being transmitted to the receiving device.

2. The video transmitting device as set forth in claim 1, wherein:
the video transmitting device control section includes a data converting section for converting a signal transmitting scheme for the video data file to be transmitted to the receiving device, the data converting section converting the signal transmitting scheme in accordance with a result of recognition of the connection request data by the connection request data recognizing section.

3. The video transmitting device as set forth in claim 2, wherein:
the storage device stores a receiving device information management table for storing information for identifying the receiving device and information on a signal transmitting scheme that allows the receiving device to receive the video data file;
the connection request data recognizing section analyzes the connection request data so as to identify the receiving device that transmitted the connection request data, and, with reference to the receiving device information management table, the connection request data recognizing section identifies a signal transmitting scheme that allows the identified receiving device to receive the video data file; and
the data converting section converts a signal transmitting scheme for the video data file to be transmitted, into the signal transmitting scheme identified by the connection request data recognizing section.

4. The video transmitting device as set forth in claim 1, wherein:
the video transmitting device control section includes a control signal recognizing section for recognizing a control signal transmitted from the receiving device; and
if the control signal recognizing section recognizes reception of a control signal for instructing operation for switching a target of reading to another video data, the file handling section switches the target of reading from one video data file to another video data file.

5. The video transmitting device as set forth in claim 1, wherein:
the file handling section reads a video data file having a predetermined file name among video data files stored in the storage device, and the transmission control section transmits the video data file to the receiving device.

6. The video transmitting device as set forth in claim 1, wherein:
the file handling section reads a video data file stored in a predetermined subdirectory among video data files stored in the storage device, and the transmission control section transmits the video data file to the receiving device.

7. The video transmitting device as set forth in claim 1, wherein:
the connection request data includes information on the video data file requested by the receiving device;
to the file handling section, the connection request data recognizing section transmits the information on the video data file requested by the receiving device; and
based on the information on the video data file requested by the receiving device, the file handling section determines a video data file to be read.

8. The video transmitting device as set forth in claim 7, wherein:
the information on the video data file requested by the receiving device is a file name of the video data file.

9. The video transmitting device as set forth in claim 7, wherein:
the information on the video data file requested by the receiving device is a name of a subdirectory in which the video data file is stored, the subdirectory being a subdirectory of the storage device.

10. The video transmitting device as set forth in claim 1, wherein:
the storage device further stores a video data file management table for storing information on the video data file; and
the video transmitting device control section includes a clock section for recording, in the video data file management table, date and/or time on which the video data file is stored in the storage device.

11. The video transmitting device as set forth in claim 10, wherein:
the file handling section reads a video data file stored in the storage device on such date and/or time that is within a predetermined range among video data files stored in the storage device, and transmits the video data file to the receiving device.

12. The video transmitting device as set forth in claim 10, wherein:
the connection request data includes information on the video data file requested by the receiving device;
to the file handling section, the connection request data recognizing section transmits the information on the video data file requested by the receiving device;
based on the information on the video data file requested by the receiving device, the file handling section determines a video data file to be read; and
the information on the video data file requested by the receiving device is a range of date and/or time on which the video data file is stored in the storage device.

13. The video transmitting device as set forth in claim 1, wherein:
the video transmitting device control section includes a control signal recognizing section for recognizing a control signal transmitted from the receiving device;
the video data file transmitted is still picture data in moving picture data; and
if a control signal for instructing moving picture reproduction is received by the control signal recognizing section, the file handling section reads a video data file that is moving picture data including the transmitted still picture data, and the transmission control section transmits the video data file to the receiving device.

14. The video transmitting device as set forth in claim 13, wherein:
if reception of a control signal for instructing switching operation to another video data is recognized by the control signal recognizing section after the still picture data is transmitted to the receiving device, the file handling section reads a video data file that is still picture data in moving picture data that is different from the moving picture data including the transmitted still picture data, and the transmission control section transmits, to the receiving device, the video data file read by the file handling section.

15. The video transmitting device as set forth in claim 13, wherein:
the connection request data includes information indicating whether or not transmission of still picture data in moving picture data is requested; and
if the connection request data recognizing section recognizes that the connection request data includes information representing a transmission request for the still picture data, the transmission control section transmits the still picture data in the moving picture data to the receiving device.

16. The video transmitting device as set forth in claim 1, wherein:
the video transmitting device control section includes a control signal recognizing section for recognizing a control signal transmitted from the receiving device;
the video data file transmitted from the transmission control section to the receiving device when the connection request data recognizing section recognizes the connection request data is list data on still picture data in plural sets of moving picture data; and
if, after the list data is transmitted to the receiving device, the control signal recognizing section recognizes reception of a control signal for instructing operation for choosing a predetermined still picture among a plurality of still pictures in a displayed list of the list data, and receives a control signal for instructing moving picture reproduction, the file handling section reads a video data file that is moving picture data including the still picture data chosen from the displayed list of the list data, and the transmission control section transmits the video data file to the receiving device.

17. The video transmitting device as set forth in claim 16, wherein:
the connection request data includes information indicating whether or not transmission of the still picture data in the plural sets of video data is requested; and
if the connection request data recognizing section recognizes that the connection request data includes information representing a transmission request for the still picture data, the transmission control section transmits, to the receiving device, still picture data for displaying a list of the plurality of still pictures.

18. The video transmitting device as set forth in claim 1, wherein:
the video transmitting device control section includes a control signal recognizing section for recognizing a control signal transmitted from the receiving device;
the video data file transmitted is list data on still picture data in plural sets of video data; and
if the control signal recognizing section receives a control signal for instructing operation for choosing a predetermined still picture among a plurality of still pictures in a displayed list of the list data, and receives a control signal for instructing moving picture reproduction, the file handling section reads a video data file that is moving picture data including the chosen still picture data, and the transmission control section transmits the video data file to the receiving device.

19. A receiving device provided to a video transmitting system in which video data is transmitted from a video transmitting device to the receiving device over a communication network, and the video data is reproduced by a display device connected to the receiving device,
the video transmitting device comprising:
a video transmitting device control section for controlling operation of the video transmitting device; and
a storage device for storing video data in a file format,
the video transmitting device control section including
a connection request data recognizing section for recognizing connection request data transmitted from the receiving device, the connection request data being data for requesting a connection with the video transmitting device;
a file handling section for reading a video data file stored in the storage device; and
a transmission control section for transmitting the video data file read by the file handling section to the receiving device,
when the connection request data recognizing section recognizes the connection request data, the transmission control section establishing a connection between the video transmitting device and the receiving device that transmitted the connection request data, and the video data file read by the file handling section being transmitted to the receiving device,
the receiving device comprising:
a receiving device control section for controlling operation of the receiving device; and
a storage device including a receiving device information management table for managing information on the receiving device,
the receiving device control section including
a connection request data generating section for generating the connection request data based on the information included in the receiving device information management table; and
a decoder section for decoding compressed video data transmitted from the video transmitting device and converting decoded video data into analog data,
the receiving device transmitting the connection request data to the video transmitting device when the receiving device is started up.

20. A receiving device as set forth in claim 19, further comprising:
an operation signal receiving section for receiving an operation signal from an external input device,
the receiving device control section including a control signal conversion section for converting the operation signal from the external input device into a control signal that can be received by the video transmitting device.

21. A video transmitting system, comprising:
a video transmitting device including (i) a video transmitting device control section for controlling operation of the video transmitting device; and (ii) a storage device for storing video data in a file format, the video transmitting device control section including (a) a connection request data recognizing section for recognizing connection request data transmitted from a receiving device, the connection request data being data for requesting a connection with the video transmitting device; (b) a file handling section for reading a video data file stored in the storage device; and (c) a transmission control section for transmitting the video data file read by the file handling section to the receiving device, when the connection request data recognizing section recognizes the connection request data, the transmission control section establishing a connection between the video transmitting device and the receiving device that transmitted the connection request data, and the video data file read by the file handling section being transmitted to the receiving device; and
a receiving device including (iii) a receiving device control section for controlling operation of the receiving device; and (iv) a storage device including a receiving device information management table for managing information on the receiving device, the receiving device control section including (d) a connection request data generating section for generating the connection request data based on the information included in the receiving device information management table; and (e) a decoder section for decoding the compressed video data transmitted from the video transmitting device and converting decoded video data into analog data, the receiving device transmitting the connection request data to the video transmitting device when the receiving device is started up, the receiving device being provided to the video transmitting system, in which video data is transmitted from the video transmitting device to the receiving device over a communication network, and the video data is reproduced by a display device connected to the receiving device.

22. A video transmitting method using a video transmitting device,
the video transmitting device comprising:
a video transmitting device control section for controlling operation of the video transmitting device in accordance with connection request data transmitted from a receiving device so as to request a connection; and
a storage device for storing video data in a file format,
the video transmitting device control section including
a connection request data recognizing section for recognizing the connection request data;
a file handling section for reading a video data file stored in the storage device; and
a transmission control section for transmitting the video data file read by the file handling section to the receiving device,
the method comprising the steps of:
recognizing information on the receiving device at the connection request data recognizing section, based on the connection request data received from the receiving device over a communication network;
reading video data at the file handling section in accordance with a result of recognition by the connection request data recognizing section; and
transmitting the video data to the receiving device.

23. A video transmitting program for causing a computer to function as a video transmitting device including (i) a video transmitting device control section for controlling operation of the video transmitting device; and (ii) a storage device for storing video data in a file format, the video transmitting device control section including (a) a connection request data recognizing section for recognizing connection request data transmitted from a receiving device, the connection request data being data for requesting a connection with the video transmitting device; (b) a file handling section for reading a video data file stored in the storage device; and (c) a transmission control section for transmitting the video data file read by the file handling section to the receiving device, when the connection request data recognizing section recognizes the connection request data, the transmission control section establishing a connection between the video transmitting device and the receiving device that transmitted the connection request data, and the video data file read by the file handling section being transmitted to the receiving device.

24. A computer-readable storage medium storing a video transmitting program for causing a computer to function as a video transmitting device including (i) a video transmitting device control section for controlling operation of the video transmitting device; and (ii) a storage device for storing video data in a file format, the video transmitting device control section including (a) a connection request data recognizing section for recognizing connection request data transmitted from a receiving device, the connection request data being data for requesting a connection with the video transmitting device; (b) a file handling section for reading a video data file stored in the storage device; and (c) a transmission control section for transmitting the video data file read by the file handling section to the receiving device, when the connection request data recognizing section recognizes the connection request data, the transmission control section establishing a connection between the video transmitting device and the receiving device that transmitted the connection request data, and the video data file read by the file handling section being transmitted to the receiving device.
